(19) United States
(12) Patent Application Publication
(10) Pub. No.: US 2020/0034874 A1
(43) Pub. Date: Jan. 30, 2020

(54) METHOD FOR MODELING MOBILE ADVERTISEMENT CONSUMPTION

(71) Applicant: Yieldmo, Inc., New York, NY (US)

(72) Inventors: Indu Narayan, New York, NY (US); David Sebag, New York, NY (US); Maziar Hosseinzadeh, New York, NY (US); Rohit Matthews, New York, NY (US); Jasmine Noack, New York, NY (US); Melody Li, New York, NY (US); Andrew Holz, New York, NY (US); Sergei Irailev, New York, NY (US); Farid Jawde, New York, NY (US)

(21) Appl. No.: 16/427,303

(22) Filed: May 30, 2019

Related U.S. Application Data
(60) Provisional application No. 62/787,195, filed on Dec. 31, 2018.
(60) Provisional application No. 62/787,188, filed on Dec. 31, 2018.
(60) Provisional application No. 62/694,419, filed on Jul. 5, 2018.
(60) Provisional application No. 62/678,194, filed on May 30, 2018.

(51) Int. Cl. G06Q 30/02

(52) U.S. Cl. CPC G06Q 30/0244; G06Q 30/0277

(57) ABSTRACT

One variation of a method for modeling mobile advertisement consumption includes: serving a first advertisement in an advertising campaign to a computing device associated with a user, accessing a first set of engagement data, recorded by the first advertisement, representing a first set of interactions between the user and the first advertisement at the computing device; accessing a model linking user interactions with a set of advertisements within the advertising campaign and a target outcome for the advertising campaign; estimating a predicted set of interactions between the user and a second advertisement in the advertising campaign based on the model and the first set of engagement data; and in response to the predicted set of interactions anticipating the target outcome, serving the second advertisement, in the advertising campaign, to the user.

### CROSS-REFERENCE TO RELATED APPLICATIONS

This Application claims the benefit of U.S. Provisional Application No. 62/678,194, filed on 30 May 2018, U.S. Provisional Application No. 62/694,419, filed on 5 Jul. 2018, U.S. Provisional Application No. 62/787,188, filed on 31 Dec. 2018, and U.S. Provisional Application No. 62/787,195, filed on 31 Dec. 2018, each of which is incorporated in its entirety by this reference.

### TECHNICAL FIELD

This invention relates generally to the field of mobile advertising and more specifically to a new and useful method for modeling mobile advertisement consumption in the field of mobile advertising.

### BRIEF DESCRIPTION OF THE FIGURES

FIG. 1 is a flowchart representation of a first method;

FIG. 2 is a flowchart representation of one variation of the first method;

FIG. 3 is a flowchart representation of one variation of the first method;

FIG. 4 is a flowchart representation of one variation of the first method;

FIG. 5 is a graphical representation of one variation of the first method;

FIG. 6 is a graphical representation of another variation of the first method; and

FIG. 7 is a flowchart representation of a second method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

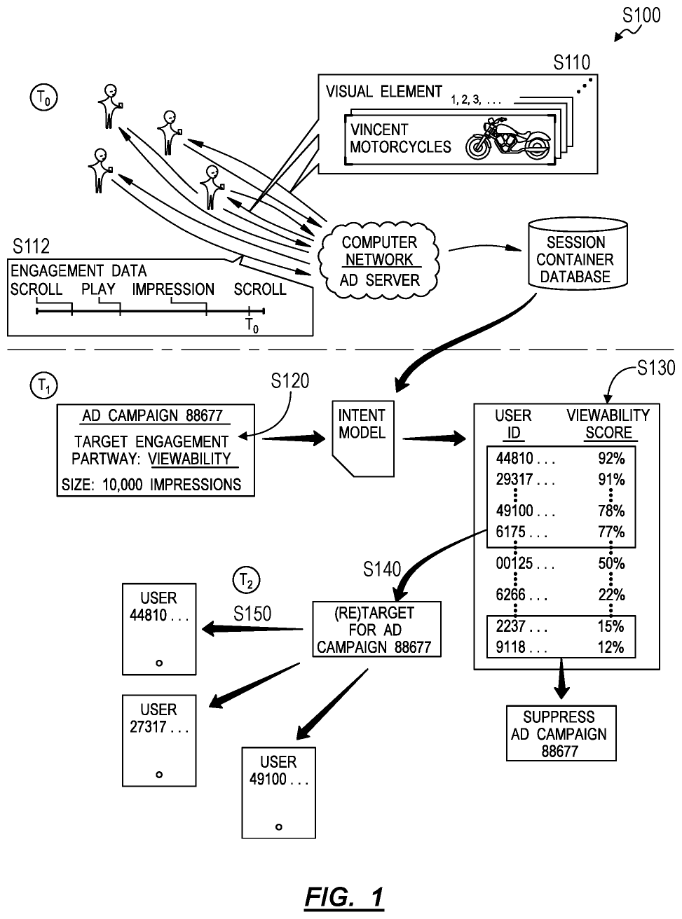

As shown in FIG. 1, a method S100 for modeling mobile advertisement consumption includes: over a first period of time, serving a set of visual elements containing advertising content to a set of computing devices of a population of users in Block S110 and receiving—from the set of visual elements—a corpus of engagement data representing interactions of the population of users with the advertising content presented within the set of advertisements inserted into webpages rendered within web browsers executing on the set of computing devices in Block S112; receiving a target outcome specified by a new advertising campaign in Block S120; calculating a probability of engagement (or the target outcome) of each user in the population of users with a new advertisement in the new advertising campaign according to the target outcome in Block S130 based on the corpus of engagement data and a predefined intent model for the target outcome; flagging a subset of users, in the population of users, associated with a greatest probability of engagement (or the target outcome) with the new advertisement according to the target outcome in Block S140; and, during a second period of time, in response to receiving a request for an advertisement from a computing device associated with a user in the subset of users, serving the new advertisement to the computing device in Block S150.

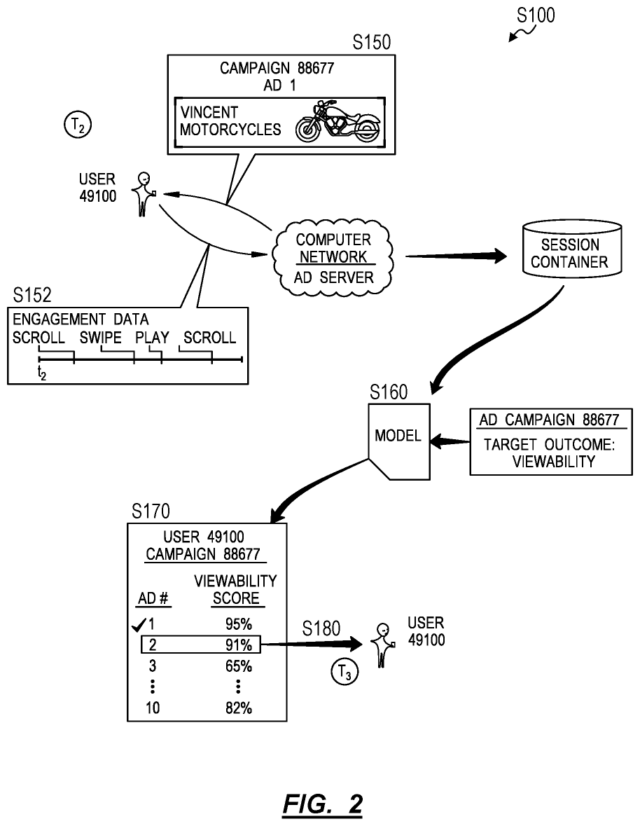

One variation of the method S100 shown in FIG. 2 includes: serving a first visual element containing a first advertisement in an advertising campaign to a computing device associated with a user in Block S150 and accessing a set of engagement data, recorded by the first visual element, representing a set of interactions between the user and the first advertisement at the computing device in Block S152; accessing a model linking user interactions with a set of advertisements within the advertising campaign and a target outcome for the advertising campaign in Block S160; estimating a predicted set of interactions between the user and a second advertisement in the advertising campaign based on the model and the set of engagement data in Block S170; and, in response to the predicted set of interactions anticipating the target outcome, serving the second advertisement, in the advertising campaign, to the user at the computing device, in Block S180.

### 1.1 Applications

Generally, Blocks of the method S100 can be executed by a computer system—such as a remote server functioning as or interfacing with an advertising server—to: leverage existing engagement data that represents past user interactions with advertising content to predict types and degrees of user interactions with advertisements served to these users during current and future advertising campaigns; to match users to current or future advertising campaigns based on predicted user interactions with advertisements in these advertising campaigns and target outcomes (i.e., types and/or degrees of user interactions) specified by these advertising campaigns; and to selectively serve advertisements (e.g., mobile advertisements) in these advertising campaigns to these matched users (e.g., to mobile computing devices, such as smartphones, associated with these users). In particular, an advertiser or creative may specify a particular target outcome for a new advertising campaign, which may achieve a particular target outcome such as a certain viewability rate or a certain brand lift. The computer system can then implement Blocks of the method S100 to preemptively isolate a group of users within a population that may engage with an advertisement in this new campaign according to this target outcome, based not only on user demographic or content contained within this advertisement but also based on specific interactions and behaviors that these users have exhibited while engaging with mobile advertisements in the past.

In one variation, the computer system can serve a first advertisement in a new advertising campaign to a user. The computer system can then implement Blocks of the method S100 to access engagement data recorded by the first advertisement, representative of interactions between the user and the first advertisement, such as the number of times the user scrolled over the first advertisement or a duration of time the first advertisement was in a viewing window on the user's computing device. Based on the target outcome specified by the advertising campaign, the computer system can select a model to predict the types and extent of interactions the user may have with a second advertisement in the advertising campaign. If the predicted interactions between the user and the second advertisement anticipate the target outcome specified by the advertising campaign, the computer system can serve the second advertisement in the advertising campaign to the user. At a later time, when the user navigates to a webpage with a request for an advertisement, the computer system can access the engagement data recorded by both the first advertisement and the second advertisement. The computer system can leverage the additional engagement data collected by the second advertisement to make another prediction of the interactions between the user and a next ad in the advertising campaign. Therefore, as more engagement data is collected by additional advertisements in the advertising campaign served to the user, the computer system can converge on a more user-specific model to predict the user's interactions with future advertisements in the advertising campaign.

For example, an advertising campaign can specify a target outcome including: viewability rate (e.g., at least a minimum time spent viewing at least a minimum proportion of an ad); click-through rate (e.g., a minimum proportion of advertisements clicked to total advertisements served); or click-through conversion rate (e.g., a minimum proportions of conversions to total advertisements served); In another example, the advertising campaign can specify a target outcome for a user interaction type or rate, such as: a minimum proportion of advertisements for which users scrolled back and forth over the advertisement at least twice (such as described in U.S. patent application Ser. No. 15/816,833) to total advertisements served; a minimum proportion of advertisements for which users selected one hotspot within the advertisement to total advertisements served; a minimum proportion of advertisements for which users swiped laterally through content within the advertisement (such as described in U.S. patent application Ser. No. 15/677,259) to total advertisements served; a minimum proportion of advertisements for which users tilted their mobile computing devices to view additional content within the advertisement to total advertisements served; a minimum proportion of advertisements for which users viewed video content within the advertisement in a native video player to total advertisements served; etc.

In another example, the advertising campaign can specify a target outcome for a specific interaction type or rate including: a minimum number of pixels of the advertisement in view of the viewing window; a minimum percentage of video content within an advertisement viewed; a minimum number of scrolls on a webpage containing the advertisement; etc. In this example, the computer system can execute Blocks of the method S100 to: predict whether a user is likely to interact with an advertisement according to the target outcome specified for this ad or for the ad campaign containing this advertisement; and then selectively serve this ad to the user based on this prediction. The computer system can therefore both decrease probability that resources allocated to serving this ad to the user result is no return (i.e., no interaction between the user and the ad or interactions not associated with the target outcome) and increase probability that the user receives ads that she perceives as engaging.

Visual elements served to the user in this population can include iframe elements loaded with static, video, and or dynamic (e.g., responsive) advertising content that can be configured to regularly record various direct and indirect engagement metrics, such as: the position of the advertisement within a viewing window rendered on a display of a computing device associated with the user; a number of pixels of the advertisement currently in view in the viewing window; clicks over the advertisement; touch events over the advertisement (i.e., inside of the visual element); touch events outside the advertisement (i.e., outside of the visual element) while the advertisement is in view in the viewing window; vertical scroll events that move the advertisement within the viewing window; horizontal swipes over the advertisement; hotspot selections within the advertisement; video plays, pauses, and resumes within the advertisement; and metadata of the webpage containing the advertisement; etc. For example, a visual element inserted into a webpage rendered within a web browser executing on a user's mobile computing device can regularly collect these engagement data and return these engagement data to the computer system. The computer system can then aggregate these engagement data collected by this visual element and by other visual elements served to the user over time and pass these engagement data—and metadata for a new advertisement or new advertising campaign—into an intent model to predict how the user will engage with this new advertisement or new advertising campaign. If this predicted engagement or interaction by the user with this new advertisement or new advertising campaign aligns with a target outcome specified for the new advertisement or new advertising campaign, the computer system can then selectively serve this new advertisement or an advertisement from this new advertising campaign to this user; otherwise, the computer system can select an alternative advertisement to serve to the user.

The computer system can implement this process asynchronously, such as before a new advertising campaign is activated (or “goes live”) to identify a corpus of users within a population most likely to engage with a new advertisement in the new advertising campaign according to the target outcome specified for this new advertisement or new advertising campaign. For example, when a new advertisement specifying a particular target outcome is loaded into the computer system, the computer system can: insert metadata for the new advertisement (e.g., content type and advertisement format) and engagement data for a user into an intent model for this set of interactions to calculate a confidence score that this user will engage with the new advertisement according to the particular target outcome; repeat this process for each other user in a population of users; rank users with the highest confidence score for engaging with this new advertisement according to the target set of interactions; flag the highest-ranking users to receive this new advertisement; and then selectively serve the new advertisement to these flagged users when webpages viewed on computing devices associated with these users request advertising content from the computer system.

Therefore, the computer system can: cooperate with advertisements served to users over time to track “behaviors” of these users and to identify users who have historically exhibited the “right” kind of behavior for a particular advertisement or advertising campaign; and then selectively target the particular advertisement or advertising campaign to these users in order to achieve a high rate of positive outcomes (e.g., brand lift, conversions) per advertisement served or dollar spent within this advertising campaign.

The computer system can also learn user behaviors or types of interactions that are the strongest indicators of a target outcome, specified for a particular advertisement, based on engagement data collected by visual elements served to users during a first segment of an advertising campaign. As the computer system converges on specific interaction types that anticipate a specific target outcome for this advertisement, the computer system can implement Blocks of the method S100 to identify and flag a next subset of users in a user population to receive the advertisement—in order to achieve this target outcome—based on historical engagement data of this next subset of users. More specifically, the computer system can execute Blocks of the method S100 to increase video plays of an advertisement by retargeting users and to personalize advertising content served to these users based on: their previous interactions with advertising content; and intent models that link advertising content, advertisement placement, and user characteristics and interactions at the computing device to certain advertising campaign outcomes.

The computer system can also learn user behaviors or types of interactions that are the strongest indicators of a target outcome for an advertising campaign, specified for a particular advertisement, for a specific user, by collecting engagement data for the user to build an intent model that can be refined as additional engagement data is collected over time. The computer system can therefore: access engagement data recorded by visual elements loaded with advertisements and served to a user's computing device; develop and refine a model for predicting the user's interactions with other advertisements within the same or different advertising campaign based on advertising format, advertisement location within a webpage, call to action with the visual element, time of day, location, operating system, etc.; and then leverage this model to select future advertisements to serve to the user.

Blocks of the method S100 are described below as executed by a computer system—such as a remote advertising server, computer network, or other remote system—operating in conjunction with visual elements that present advertising content to users and record user interactions with this advertising content. However, Blocks of the method S100 can be executed by any other local or remote entities to selectively and intelligently serve visual elements (including advertisements) to users based on target outcomes specified for these advertisements or target outcomes specified by advertising campaigns and historical user engagement data. The method S100 is also described below as executed to intelligently serve visual elements to smartphones for insertion of these visual elements into webpages viewed within mobile web browsers executing on smartphones. However, the method S100 can be executed to selectively serve advertisements for insertion into native applications, web browsers, or electronic documents executing on or accessed through any other mobile or desktop device.

### 1.2 Visual Elements

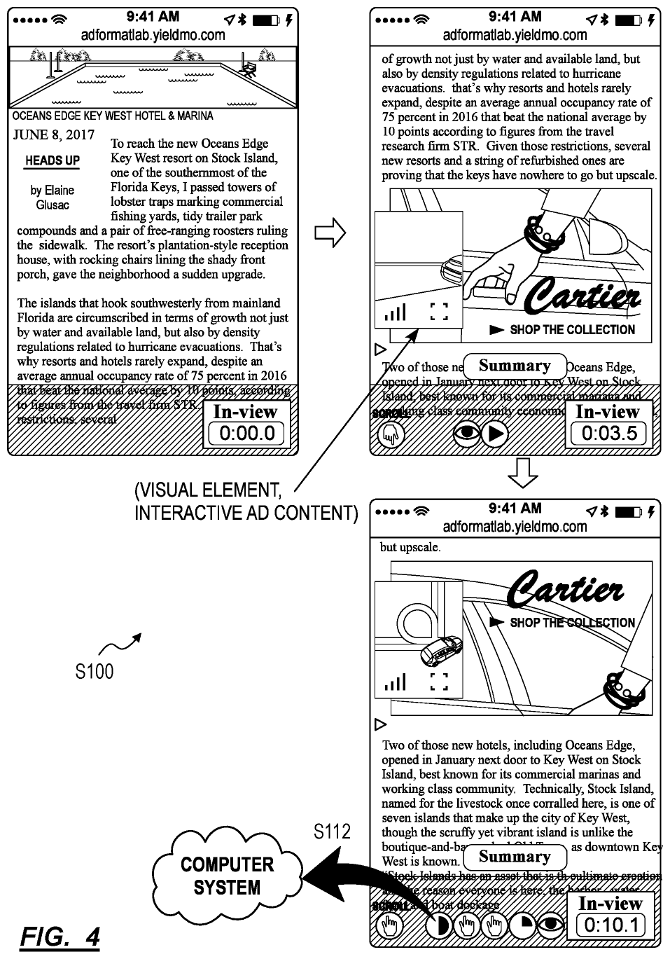

Generally, the computer system can serve visual elements—containing advertising content and configured to record various engagement data and to return these engagement data to the computer system—to user computing devices for insertion into advertisement slots within webpages rendered within web browsers executing on these computing devices. In one example, a visual element can include an iframe element that contains static or dynamic (e.g., interactive) advertising content and that is configured to be inserted into a webpage, to record various engagement data, and to return these engagement data at a rate of 5 Hz once the visual element is loaded into a webpage rendered in a web browser executing on a computing device, as shown in FIG. 4.

In this example, the visual element can record: its position in the web browser; a number or proportion of pixels of the visual element in view in the web browser; a running time that a minimum proportion of the visual element has remained in view; a number or instances of clicks on the visual element; vertical scroll events over the webpage; quality of these scroll events; horizontal swipes over the visual element; panes in the visual element viewed or expanded; tilt events and device orientation at the computing device while the visual element was in view in the web browser; number or instances of hotspots selected; instances or duration of video played within the visual element; video pauses and resumes within the visual element or an expanded native video player; time of day; type of content on the webpage or other webpage metadata; and/or a unique user identifier. The visual element can compile these engagement data into engagement data packets and return one engagement data packet to the remote computer system once per 200-millisecond interval, such as over the Internet or other computer network.

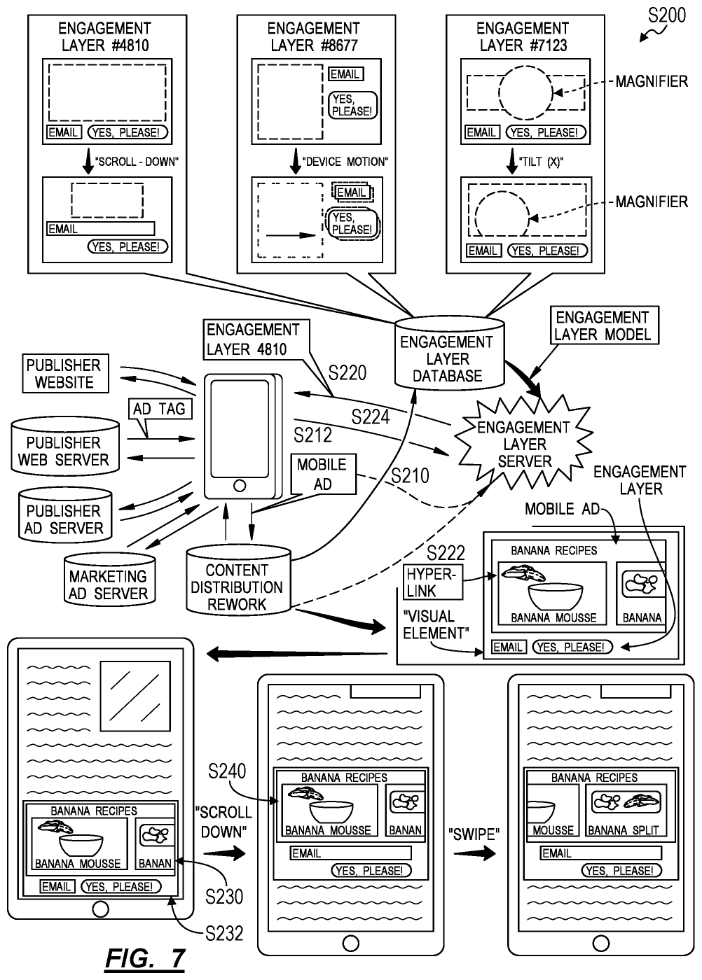

The visual element can also include an engagement layer, as described below. The visual element can render an advertisement wrapped with or modified by an engagement layer to form an interactive composite advertisement that responds to (i.e., changes responsive to) actions occurring on a mobile device, such as scroll, swipe, tilt, or motion events as described below and shown in FIG. 7. Generally, the visual element can configure an engagement layer to overlay a mobile advertisement or configure the engagement layer for placement along one or more edges of a mobile advertisement. The visual element can include and/or animate a call to action (hereinafter “CTA”), such as a textual statement or icon configured to persuade a user to perform a particular task, such as purchasing a product, signing up for a newsletter, or clicking-through to a landing page for a brand or product.

In one example, a visual element (e.g., an iframe element) is inserted into an advertisement slot on a webpage accessed at a mobile device; and an advertising server and/or the remote computer system load a mobile advertisement (e.g., creative content arranged statically or dynamically according to an advertisement format) and an engagement layer into the visual element as the webpage loads on the mobile device. The visual element then: locates the mobile advertisement within the visual element; and locates the engagement layer adjacent one edge (e.g., along a left side, right side, top, or bottom) of the mobile advertisement; (animates the mobile device responsive to an advertisement coming into view of a viewing window rendered on the mobile device based on interactions specified by the mobile advertisement;) and animates the engagement layer based on interactions specified by an engagement layer model. Alternatively, the visual element can: locate the engagement layer along multiple edges (e.g., the bottom and right edges) of the mobile advertisement; and locate the mobile advertisement over and inset from the engagement layer such that the engagement layer forms a background or perimeter around the mobile advertisement.

However, the visual element can define any other file format, can be loaded with advertising content of any other type, and can collect and return engagement data of any other type to the remote computer system in any other way and at any other interval once the visual element is loaded into a webpage rendered within a web browser on a computing device.

### 1.3 Ad Session

Upon receipt of a set of engagement data packets from a visual element served to a user's computing device, the remote computer system can compile these engagement data packets into a session container. For example, the computer system can compile engagement data recorded by the visual element from an initial time that the visual element is loaded into the webpage until the webpage is closed (e.g., by navigating to another webpage or closing the web browser) (i.e., a “session, such as up to a duration of thirty minutes) into a multi-dimensional vector representing all behaviors performed by the user within this session, combinations or orders of these behaviors, and/or advertisement or webpage metadata. The computer system can store this session container with a unique identifier assigned to the user or computing device at which the user viewed this advertisement.

The computer system can repeat this process to compile engagement data received from other advertisements served to the same computing device (or to the same user, more specifically) over time into a set of session containers linked to this computing device (or to this user specifically). The computer system can further implement this process to build a series of session containers linked to other computing devices (or to other users) within a population based on engagement data received from advertisements served to these computing devices over time.

### 1.4 Intent

The computer system can also implement an intent model configured to predict whether a user will interact with an advertisement according to a particular target outcome, when served this advertisement (e.g., a prediction of the user's “intent” to interact with the advertisement, a prediction of the user's propensity to interact with the advertisement according to the particular target outcome) based on historical engagement data collected by advertisements previously served to this user.

For example, the computer system can store a predefined “viewability” model configured to intake a series of historical session containers of a user and to output a probability that the user will scroll down to an advertisement inserted into a webpage and that a minimum proportion of this advertisement will be rendered on the user's computing device for at least a minimum duration of time based on these engagement data. The viewability model can also: intake metadata of an advertisement, such as the format of the advertisement (e.g., static or interactive with video, catalog, virtual reality, or hotspot content) and a type of brand or product advertised; and output a probability that a user will scroll down to this advertisement inserted into a webpage viewed on the user's computing device and that the minimum proportion of this advertisement will be rendered on the user's computing device for at least the minimum duration of time based on historical user engagement data and these advertisement metadata. Furthermore, in the variation described below in which the computer system implements an intent model in real-time to select an advertisement best matched to a user, the viewability model can also: intake time, location, and/or webpage metadata (e.g., a length of the webpage, types of media contained within the webpage, and/or type of the website hosting the website, such as a news or lifestyle website) for a current web browsing session at the user's computing device; and output a probability that a user will scroll down to this advertisement inserted into this webpage viewed on the user's computing device at the current time and that the minimum proportion of this advertisement will be rendered on the user's computing device for at least the minimum duration of time based on historical user engagement data, advertisement metadata, and website metadata.

The computer system can similarly implement other intent models, such as: a conversion model that outputs a probability that a user will convert through an advertisement served to a webpage accessed on the user's computing device; a click-through model that outputs a probability that a user will click on an advertisement; a scroll interaction model that outputs a probability that a user will scroll back and forth over an advertisement at least a minimum number of times; a hotspot model that outputs a probability that a user will select at least a minimum number of hotspots within an interactive advertisement; a swipe model that outputs a probability that a user will swipe laterally through content within an advertisement; a virtual reality model that outputs a probability that a user will manipulate a virtual advertisement environment within an advertisement to at least a minimum degree; a video model that outputs a probability that a user will view at least a minimum duration or proportion of a video within an advertisement; and/or a brand lift model that outputs a probability that a user will exhibit at least a threshold increase in brand recognition after an advertisement is served to the user's computing device; etc.

In one example, the computer system implements an intent model that correlates user interactions to likelihood that a user will perform a downstream action separate from the target interactions for the advertisement, such as: make a physical or digital purchase; exhibit greater brand recognition; spend more time within an advertiser's website; or exhibit greater lifetime value as a customer of the advertiser. In this example, the computer system can serve brand lift, product purchase, and/or other surveys to these users over time, link results of these surveys to related advertisements previously served to these users, and then implement linear regression, artificial intelligence, a convolutional neural network, or other analysis techniques to develop an intent model linking advertising content previously served to these users, placement of these advertisements, user characteristics, and user interactions with advertisements to these outcomes indicated in these surveys.

### 1.4.1 Single Intent Model

Alternatively, the computer system can implement a single intent model that outputs a probability that the user will interact with an advertisement according to all of the foregoing interaction types based on historical user engagement data, advertisement metadata, and/or website metadata.

### 1.4.2 Dynamic Intent Model

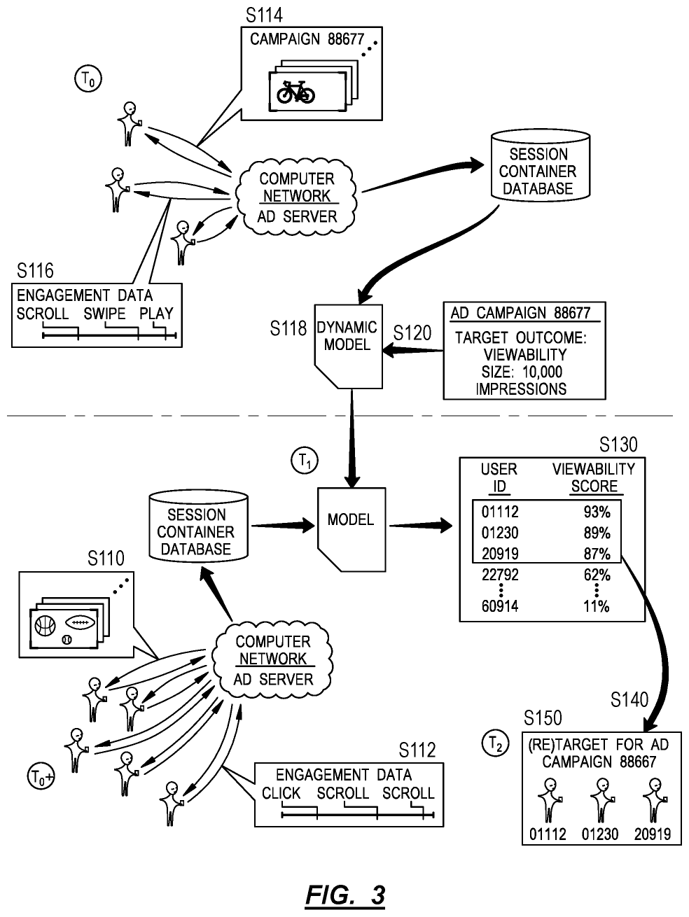

In one variation, the computer system automatically develops (or “learns”) an intent model for a particular advertisement based on engagement data recorded by advertisements served to a first subset of users in a user population during a first segment of a new advertising campaign, such as during a short, initial test run of the new advertising campaign. Once the computer system has converged on a particular user interaction, combination of user interactions, and/or sequence of user interactions for this advertisement that anticipate a particular outcome (e.g., viewability, conversion, click-through, brand lift, video consumption, etc.) specified for this particular advertisement or advertising campaign, the computer system can leverage this intent model for this particular advertisement to flag a second subset of users in the population to receive the particular advertisement—based on historical engagement data of these users—as described below and as shown in FIG. 3. Therefore, the computer system can implement Blocks of the method S100 to automatically test a new advertisement across a first (small) group of users in Block S114, collect engagement data in Block S116 for this first group of users through this new advertisement, served to computing devices of these users, develop an intent model linking user interactions with the new advertisement to a specified target outcome based on these engagement data in Block S118, and then leverage this intent model and historical engagement data of other users to intelligently identify a second group of users most likely to engage with the advertisement according to this target set of interactions, identified by the model, which may anticipate the target outcome.

The computer system can implement similar methods and techniques to develop an intent model for a particular advertisement format, for a particular advertising campaign, for a particular advertisement slot on a webpage, for a particular advertisement slot location on a webpage, etc. and to leverage this intent model to intelligently identify a group of users most likely to interact—with an advertisement of this type and/or served in this way—according to a particular set of interactions.

### 1.4.3 Prepopulated User Targets for New Advertising Campaign

A new advertising campaign can be loaded into the computer system or otherwise activated by an advertiser or creative and can include: a single advertisement in a single advertisement format, a single advertisement in multiple formats, or multiple advertisements in one or more formats, etc.; and a target outcome for users viewing advertisements within this advertising campaign. The computer system can then implement the intent model for this target outcome and historical engagement data for a population of users in order to rank these users by predicted user intent to engage with an advertisement in this campaign according to a target set of interactions specified by the advertisement, associated with achieving the target outcome in this new advertising campaign.

In one implementation, the computer system can aggregate a population of users who may be candidates for serving an advertisement in the new campaign, such as by user demographic (e.g., age, gender), location, and/or other characteristics specified by the new advertising campaign. The computer system can then derive intents of users in this population to engage with the advertisement in the advertising campaign according to the specified target outcome based on historical engagement data collected through advertisements previously served to these users. For example, for a single user, the computer system can: compile engagement data collected by advertisements served to this user over time into a series of session containers; and pass these session containers into the intent model—corresponding to a target outcome specified by the new advertising campaign—to calculate a probability that the user will engage with an advertisement in this campaign according to the target outcome.

In this example, the computer system can also access metadata for the new advertising campaign or for a specific advertisement in the new advertising campaign, such as: the format of the advertisement (e.g., whether the advertisement is static, includes video content, or is interactive); content within the advertisement (e.g., the type of product or brand represented in the ad); a target location of the advertisement presented on a webpage (e.g., at the top or bottom of the webpage); whether the advertising campaign includes a series of advertisements designated for presentation in a particular order or a contiguous series; or time of day or time of year that the new advertising campaign is scheduled to be live; etc. The computer system can then inject these metadata into the intent model alongside engagement data for the user in order to predict the user's intent to engage with the advertisement or advertising campaign with greater accuracy and/or contextual understanding for how the advertisement is served to users. The computer system can represent this predicted probability—that the user will engage with the advertisement according to the target outcome—as a score (e.g., a “confidence score”).

The computer system can repeat this process for other each other user in the population to calculate a likelihood that each user in this population will engage with an advertisement in this new advertising campaign according to the specified target set of interactions and represent these likelihoods as scores. The computer system can then rank users in this user population by their scores and generate a list of users most likely to engage with the advertisement in the new advertising campaign according to the target outcome based on these scores. For example, the computer system can: retrieve a target size of the advertising campaign (e.g., 10,000 impressions); set a target number of users in the population to receive the advertisement based on a size of the advertising campaign, such as 50%, 100%, or 200% of the target size of the advertising campaign; identify the target number of users in the population associated with the highest scores; and flag this subset of users to receive the advertisement (or an advertisement in the advertising campaign) while the new advertising campaign is active.

(In one variation, as the new advertising campaign is configured by an advertiser or creative, the computer system can also serve a quantitative value of users in the population—predicted to interact with the new advertisement according to the specified target set of interactions with a confidence score greater than a threshold score (e.g., 70%)—to the advertiser or creative in order to assist the advertiser or creative in setting a magnitude of the new advertising campaign.)

In another variation, the computer system can implement Blocks of the method S100 to: access a model to predict a likely set of interactions between the users and a new advertisement in an advertising campaign; access a target set of interactions that may anticipate the target outcome specified by the advertising campaign; calculate a deviation between the predicted set of interactions and the target set of interactions for each user; and, in response to the deviation falling below a target threshold for a subset of users, flag the subset of users to receive the new advertisement.

Later, when a user navigates to a publisher's webpage via a web browser executing on her smartphone, tablet, or other computing device, a web server hosted by the publisher can return content or pointers to content for the webpage (e.g., in Hypertext Markup Language, or “HTML”, or a compiled instance of a code language native to a mobile operating system), including formatting for this content and a publisher advertisement tag that points the web browser or app to the publisher's advertising server (e.g., a network of external cloud servers). The computer system—functioning as an advertising server—can then test an identifier of the user's computing device to determine whether the user was previously flagged to receive the advertisement in the new campaign; if so, the computer system can return this advertisement directly to the web browser executing on the user's computing device. Alternatively, if this user was not flagged to receive the new advertisement, the computer system can: select and return an alternative advertisement to the user's computing device, such as an advertisement for another advertising campaign that is currently active and for which the predicted intent of the user is better matched. Furthermore, rather than deliver this advertisement directly to the user's computing device, the computing device—functioning as an advertising server—can return a third advertisement tag that redirects the web browser or app to a content delivery network, which may include a network of cloud servers storing raw creative graphics for the advertisement, and the content delivery network can return the selected advertisement to the web browser.

Therefore, each time a computing device—associated with a user previously predicted to engage with an advertisement in the new advertising campaign according to the specified target outcome—requests an advertisement from the computer system, the computer system can automatically serve this advertisement to the user or interface with an external advertising server to serve this advertisement to the user. The computer system can thus leverage historical engagement data collected by advertisements containing advertising content previously served to users in this population and existing intent models: to predict intent of these users to engage with advertising content; and to preemptively flag select users to receive advertisements—in a new advertising campaign—in the future based on alignment between predicted intent and a target outcome specified by this new advertising campaign.

### 1.5 Multiple Target Outcomes

In one variation, the new advertising campaign specifies multiple target outcomes, serving one or a series of advertisements within the advertising campaign. In this variation, the computer system can: implement similar methods and techniques to calculate a score for intent to engage by a user, according to each target outcome; merge scores for these target outcomes into composite scores for each user in the population; rank or flag users associated with the highest composite scores (i.e., exhibiting greatest likelihood of engaging with advertisements in the new advertising campaign according to the specified target outcomes); and then selectively serve the ad(s) in this new campaign to these highest-ranking users accordingly.

### 1.6 Real-Time Advertisement Selection: Intra-Webpage

In one variation, the computer system can match a user to a particular advertisement or advertising campaign based on: historical engagement data collected by advertisements served to the user's computing device—such as within the past few seconds, minutes, hours, days, weeks, or years; and target outcomes specified for various active advertisements or advertising campaigns.

### 1.6.1 Multiple Empty Advertisement Slots

In one implementation, the user visits a webpage containing multiple advertisement slots, such as a first advertisement slot proximal the top of the webpage, a second advertisement slot proximal a middle of the webpage, and a third advertisement slot proximal the bottom of the webpage. Upon receipt of a request to serve visual elements to the user's computer system for insertion into these advertisement slots in the webpage, the computer system (functioning as an advertising server) can: then implement a generic advertisement selector to select a first advertisement for a first campaign (e.g., a “default” ad), such as based on the location of the user's computing device, content on the webpage, known attributes of the host website, and/or other limited available user or webpage metadata; and serve this first advertisement—packaged in a first visual element—to the user's computing device for insertion into the first advertisement slot on the webpage. The computer system can also serve empty advertisement slots—defining advertisement placeholders—to the computing device for insertion into the second and third advertisement slots on the webpage.

Once loaded into the webpage, the first visual element can collect and return engagement data to the computer system, such as in real-time at a rate of 5 Hz. The computer system can aggregate these data into a session container, as described above, and pass this session container into an intent model to predict a likelihood that the user will scroll down to the second advertisement slot on the webpage and a most likely outcome of the user engaging with a second advertisement in the second advertisement slot once the second advertisement slot comes into view on the user's computing device. The computer system can then: identify a particular advertisement—in a set of advertisements in a set of advertising campaigns that are currently active—associated with a particular target outcome that matches the most likely set of interactions of the user for the second advertisement slot; and serve this particular advertisement to the user's computing device for immediate insertion into the second advertisement in the second advertisement slot on the webpage before the user scrolls down to the second advertisement.

In this implementation, the computer system can repeat the foregoing process: to select a third advertisement associated with a particular target outcome matched to a most-likely set of interactions of the user engaging the advertising content in the third advertisement slot, such as based on engagement data collected by both the first and second advertisements; and to return this third advertisement to the user's computing device in near real-time and before the user scrolls down to the third advertisement, now containing this third advertisement.

In this implementation, the computer system can therefore leverage engagement data collected by one advertisement loaded onto the webpage, an existing intent model, and target sets of interactions assigned to advertisements in various active advertising campaigns to select an advertisement specifying a goal matched to a likely behavior of the user.

In this implementation, the computer system can implement similar methods and techniques: to serve an empty advertisement slot to a webpage accessed by a user's computing device; to collect engagement data through this empty advertisement slot; to predict a likely set of interactions for the user based on initial interactions of the user within the webpage, as recorded by the empty advertisement slot; to select an advertisement associated with a particular target set of interactions matched to the most-likely set of interactions of the user engaging the advertisement in this advertisement slot; and to return this advertisement to the computer system—for rendering within the advertisement slot—in (near) real-time and before the user scrolls down to this advertisement within the webpage.

### 1.6.2 Default Advertisements and Intra-Webpage Advertisement Exchange

In a similar implementation, when the user visits a webpage containing an advertisement slot on her computer system and the computer system receives a request for an advertisement to render in this advertisement slot, the computer system can: implement an advertisement selector to select a first or “default” advertisement based on limited user and/or webpage metadata, such as described above; and then serve an advertisement containing this default advertisement to the user's computing device. As the advertisement—containing the default advertisement—collects and returns engagement data to the computer system in real-time, the computer system can pass these engagement data into an intent model to estimate a predicted set of interactions between the user and the advertisement, as described above. If the intent model outputs a probability or a confidence score—for a particular set of interactions—that exceeds a threshold confidence (e.g., 80%), the computer system can then implement methods and techniques described above to select a second advertisement specifying a target set of interactions matched to this predicted intent of the user and then return this second advertisement to the user's computing device for insertion into the advertisement slot in replacement of the default advertisement, all prior to the user scrolling down the webpage to the advertisement. The computer system can then render this second advertisement rather than the default advertisement, which may be more likely to achieve a target outcome, for this specific user, better matched to the target outcome of the second advertisement than the default advertisement.

Therefore, by loading a default advertisement into an advertisement slot within the webpage, the computer system can guarantee that an advertisement is available for presentation to a user within an advertisement slot on the webpage. The computer system can then selectively replace this default advertisement with a second advertisement specifying a target outcome better aligned to a likely intent or set of interactions of the user—as predicted by engagement data collected by the advertisement during initial interactions of the user within the webpage—thereby increasing the value of served advertisements for advertisers and increasing relevance of these advertisements for the user.

### 1.6.3 Floating Advertisements

In a similar implementation, as the visual element collects additional engagement data and returns these engagement data to the computer system, the computer system can repeat the foregoing process to: reevaluate the user's intent based on a large corpus of engagement data collected during this session; to select a next advertisement better matched to the revised prediction of the user's intent; and to serve this next advertisement to the advertisement slot.

In particular, the computer system can serve a visual element containing “floating” advertising content. As one or more visual elements—loaded onto the webpage—collect more engagement data and push these engagement data back to the computer system, the computer system can regularly implement the foregoing methods and techniques to: predict the intent of the user; to identify a current advertising campaign specifying a target outcome best matched to the predicted intent of the user; and to serve advertisements from this campaign to one or more visual elements within the webpage. Upon receipt of these new advertisements from the computer system, these visual elements can update to render these new advertisements in replacement of advertisements loaded previously into these visual elements. More specifically, as the user scrolls up and down a webpage, selects advertisements on the page, swipes advertisements on the page, or otherwise interacts with the webpage and visual elements contained within the webpage: visual elements loaded onto the webpage can collect additional engagement data and return these engagement data to the computer system; and the computer system can repeatedly recalculate the user's intent from these data, select an advertising campaign specifying an outcome best matched to the current predicted intent of the user, and selectively push an advertisement from this campaign to visual elements within the webpage.

For example, upon selecting a next advertisement to serve to the user, the computer system can load this next advertisement into all advertisement slots on the webpage. Each advertisement slot not currently within the visible viewing window of the web browser rendered on the user's computing device can then load this next advertisement. The user may then view this next advertisement upon either scrolling up or down within the webpage to bring one of these advertisement slots into view in the viewing window.

Alternatively, the computer system can implement the foregoing methods and techniques to select a next advertisement for an individual advertisement slot within the webpage based on engagement data collected by these visual elements and/or by other visual elements on the page. Upon receipt of a next advertisement from the computer system, the visual element can: immediately transition into rendering this next advertisement; or only render this next advertisement—in replacement of a previous advertisement loaded into the advertisement slot—when the advertisement slot is located outside of the visible viewing window of the web browser rendered on the user's computing device.

### 1.6.4 Inter-Webpage Advertisement Selection

In a similar implementation, the computer system can select a default advertisement for insertion into a first visual element on a webpage visited on a computing device and serve a first visual element containing this default advertisement to the computing device for insertion into the first advertisement slot on the first webpage. The first visual element can then implement the foregoing methods and techniques to record engagement data and to serve these engagement data back to the computer system, such as at a rate of 5 Hz, while the user navigates through the first webpage. The computer system can then compile these data into a session container and compare this session container to an intent model to predict the user's intent to click on an advertisement, swipe an advertisement, etc. For example, the computer system can execute this process: in real-time upon receipt of each new packet of engagement data from the first advertisement; once per preset time interval (e.g., once per ten-second interval); immediately after the user navigates out of the first webpage, such as by selecting a link to another webpage or after closing the web browser, events which the first advertisement may detect and return to the computer system; or responsive to any other trigger or timed event.

Once the computer system thus predicts the user's intent, the computer system can: identify a current advertising campaign specifying a target outcome best matched (or suitably matched) to the user's intent; select a particular advertisement within this advertising campaign for the user; and then queue this particular advertisement for service to the user upon visiting a next webpage. Then, when the user accesses a next webpage within the web browser and the computer system receives a request for a second advertisement for insertion into a second visual element in the second webpage, the computer system can serve a second visual element containing this particular advertisement to the user's computing device. The second visual element can then render this particular advertisement within the second webpage; the user may thus be relatively highly likely to interact with the particular content in the new advertisement according to the target set of interactions specified for the particular alignment feature.

### 1.7 User Engagement Profile

As visual elements—loaded into advertisement slots within webpages visited by the user—collect engagement data and return these engagement data to the computer system over time, the computer system can compile these engagement data into an “engagement profile” of the user. This engagement profile can thus contain information representing the user's historical interactions with advertisements: of certain types or formats; containing certain content or media; loaded onto websites of certain types or containing certain information; located in certain locations on webpages (e.g., tops or bottoms of webpages); at certain times of day or year; etc. For example, the user's engagement profile can contain a corpus of session containers compiled from engagement data collected from advertisements viewed by the user over time, and the computer system can update the user's engagement profile in (near) real-time upon receipt of engagement data from advertisements served to a computing device associated with this user.

When the user visits a next webpage containing a visual element and the computer system receives a request for an advertisement to insert into the advertisement slot, the computer system can then: pass the user's engagement profile and website metadata into an intent model to predict the type and/or degree of the user's interaction with an advertisement on this webpage; identify a particular advertising campaign specifying a target set of interactions best or sufficiently matched to the predicted intent of the user; and then serve an advertisement from this particular advertising campaign to the user's computing device. The computer system can therefore leverage: engagement data collected by advertisements over time and across many webpages viewed by the user; and metadata of a website currently selected at the user's computing device (or loading, or loaded onto the user's computing device) to predict the user's intent to engage with an advertisement at a particular webpage location and within the context of this webpage and to intelligently match this intent to an advertisement or advertising campaign with a stated goal (i.e., a target outcome) sufficiently aligned to the user's intent.

### 1.8 Look-Alike Users

In one variation, visual elements served to a website viewed by a new user (or to a user who recently deleted her cookies or other identity-linking information on her computing device) collect engagement data for this new user and return these engagement data to the computer system. However, this limited volume of engagement data for the user may enable the computer system to predict the new user's intent with limited confidence and/or limited accuracy. Therefore, rather than transforming these engagement data directly into an intent of this new user, the computer system can: compare these engagement data of the new user to more comprehensive engagement data of an existing corpus of users to identify a particular existing user (or a particular composite representation of a group of similar existing users) that exhibit behaviors similar to those of the new user. The computer system can then leverage these more comprehensive engagement data of the particular existing user (or the particular composite representation of multiple existing users) to predict the new user's intent with greater confidence and/or accuracy, rather than relying exclusively on limited engagement data collected from the new user over a limit period of time. For example, the computer system can: assign a high weight to limited existing engagement data of the new user; assign a lower weight to engagement data of the particular existing user (or the particular composite representation of multiple existing users) matched to the new user; combine these weighted engagement data into a composite body of engagement data for the new user; and then pass this composite body of engagement data into an intent model to predict the new user's current intent to interact with advertisements. The computer system can then implement methods and techniques described above to select a particular advertisement best matched to this predicted intent of the new user—bolstered by historical engagement data of other similar users—and to serve this particular advertisement to the new user.

### 1.9 Campaign Visualization and Tracking

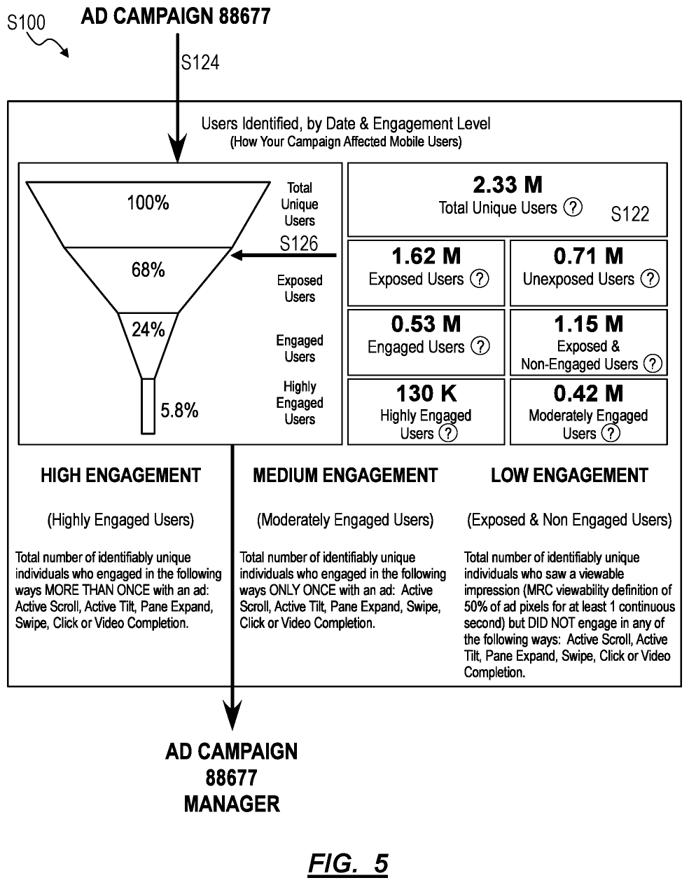

In one variation, the computer system aggregates engagement data for a population of users served an advertisement within an advertising campaign and compiles these engagement data into a visualization for the advertising campaign, as shown in FIG. 5. In particular, the computer system can: group users—in a population of users previously served an advertisement in this campaign—by degree and/or type of engagement with the advertisement; and generate a funnel visualization depicting proportions of users in this population that exhibited increasing levels of engagement with the mobile advertisement. By then serving this funnel visualization to a campaign manager for the advertising campaign—such as through a campaign portal accessed through a web browser—the computer system can quickly, visually inform the campaign manager of effectiveness of the advertising campaign in funneling users toward a target set of interactions specified for this advertisement (or specified for this advertising campaign more generally). The campaign manager may then leverage this funnel visualization to inform adjustment of the advertising campaign, such as replacing the advertisement or redefining the target set of interactions. Similarly, the computer system can leverage engagement data compiled for the funnel visualization to isolate a subset of users to retarget with a second instance of the same advertisement or with a different advertisement in the same advertising campaign in order to drive these users toward the target set of interactions specified for the advertising campaign.

### 1.9.1 Funnel Visualization

In one implementation, the computer system segments a population of users previously served an advertisement in an advertising campaign into groups of users exhibiting discrete ranges or types of engagement with the advertisement. For example, the computer system (or an advertising server, etc.) can implement Blocks of the Method S100 to serve an advertisement—within an advertising campaign—to a population of users (or “total unique users”) over time in Block S110; a first fraction of this population of unique users (or “exposed users”) may be exposed to at least a minimum proportion of the advertisement for a minimum duration of time (e.g., at least 50% of the area of the advertisement for at least one second); a second fraction of this first fraction of the population of unique users (or “engaged users”) may exhibit at least a minimum interaction with the advertisement (e.g., at least one scroll, tilt, pane-expand, swipe, click, or video-completion event); and a third fraction of this second fraction of the population of unique users (or “highly-engaged users”) may exhibit multiple such interactions with the advertisement. In this example, a funnel visualization can thus define four inset groups of users, including: total unique users; exposed users; engaged users; and highly-engaged users. In this example, as the computer system accesses user engagement data for an advertisement in an advertising campaign in Block S112, the computer system can: segment these interaction data by total unique users, exposed users, engaged users, and highly-engaged users who were served this advertisement in Block S122; retrieve a copy of this parametric funnel visualization in Block S124; and inject these total unique user, exposed user, engaged user, and highly-engaged user quantities into the parametric funnel visualization to generate a funnel visualization that depicts the current status of user engagement with the advertisement in Block S126. The computer system can then serve this funnel visualization to a campaign manager in Block S128 to manage the trajectory of the advertising campaign based on the current status of user engagement with the advertisements in the advertising campaign.

In this example, the computer system can also calculate other metrics for the advertisement, such as: users who were served the advertisement but not exposed to the advertisement (or “unexposed users,” calculated by subtracting the number of exposed users from the total number of unique users); users who were exposed to the advertisement but not engaged (or “exposed & non-engaged users,” calculated by subtracting the number of engaged users from the number of exposed users); and users who were moderately engaged (or “moderately-engaged users,” calculated by subtracting the number of highly-engaged users from the number of exposed users). The computer system can then present these additional quantitative metrics to the campaign manager—such as via the campaign portal—as shown in FIG. 5.

In this implementation, the computer system can implement fixed engagement values or ranges for each of these exposed user, engaged user, and highly-engaged user groups. For example, an instance of an advertisement served to a user can implement methods and techniques described above and in U.S. patent application Ser. No. 16/119,819—filed on 31 Aug. 2018 which is incorporated in its entirety by this reference—to: track a proportion of pixels in the advertisement contained within a viewing window rendered on a display of the user's computing device per time interval (e.g., per 200-millisecond time interval) that the instance of the advertisement is loaded on the user's computing device; and to stream these timestamped proportional values back to the computer system. The computer system can then integrate these proportions over time to calculate total time that the instance of the advertisement was in view on the user's computer system weighted by the proportion of the advertisement that was rendered on the user's computing device (e.g., a “time spent” or “viewability score”). The computer system can then implement a threshold time spent value to qualify this instance of the advertisement as an impression for the user, such as “0.5% pixel-seconds,” which may represent: 100% of the advertisement area rendered on the user's computing device for half of one second; 50% of the advertisement area rendered on the user's computing device for one second; or 25% of the advertisement area rendered on the user's computing device for two seconds. Thus, if the time spent calculated for this instance of the advertisement served to the user's computing device exceeds this threshold time spent, the computer system can count this instance of the advertisement as an advertisement impression. Alternatively, the computer system can implement an advertisement impression limitation that specifies 50% of an advertisement area be rendered on the user's computing device for at least one second for the instance of an advertisement to be counted as an advertisement impression; the computer system can thus count this instance of the advertisement as an advertisement impression only if timestamped proportional values received from the instance of advertisement indicate that 50% of the advertisement came into view on the user's computing device and remained in view for at least one second (e.g., for five consecutive time intervals for 200 milliseconds).

In another example, the advertising campaign specifies a set of interactions that qualify as engaging behavior for the advertisement, such as given: a format of the advertisement (e.g., a static advertisement versus a video advertisement; responsive behaviors of the advertisement (e.g., responsiveness to scroll events versus responsiveness to swipe events); and/or a target outcome for the advertisement (e.g., entry of an email address versus click-through versus viewing a video to completion). For example, the computer system can specify: scroll events, click-throughs, and time spent values greater than 2.0% pixel-seconds as engaging behavior for all advertisements; consumption of 25% or four seconds of a video as engaging behavior for a video advertisement; swipe events as engaging behavior for advertisements configured to respond to swipe inputs; and tilt events as engaging behavior for advertisements configured to respond to tilt inputs. Thus, for an instance of an advertisement served to a user's computing device and counted as an advertisement impression as described above, the computer system can: retrieve a target set of interactions that qualify as engaging behavior for the advertisement; and count this instance of the advertisement as an “engaged” advertisement impression if at least one interaction in this set of interactions was indicated in advertisement session data received from this instance of the advertisement.

The computer system can similarly implement a second threshold or rule for multiple instances of one interaction or for combinations of different interactions that qualify as “highly-engaging” behavior. For example, for an instance of an advertisement served to a user's computing device and counted as an “engaged” advertisement impression as described above, the computer system can count this instance of the advertisement as a “highly-engaged” advertisement impression if: two scroll events; one scroll event and one tilt event (e.g., tilting the computing device by more than 15°); or one scroll event and one swipe event was indicated in advertisement session data received from this instance of the advertisement. The computer system can count this instance of the advertisement as a “highly-engaged” advertisement impression if this instance of the advertisement resulted in a click-through or if more than 75% of the duration of a video contained in the advertisement was played back during this advertisement impression.

However, in this implementation, the computer system can implement any other method or technique to distinguish total unique users, exposed users, engaged users, and highly-engaged users who were served an advertisement in an advertising campaign. The computer system can then generate a funnel visualization that depicts quantities of users (or quantities of instances of the advertisement served to users) in these groups.

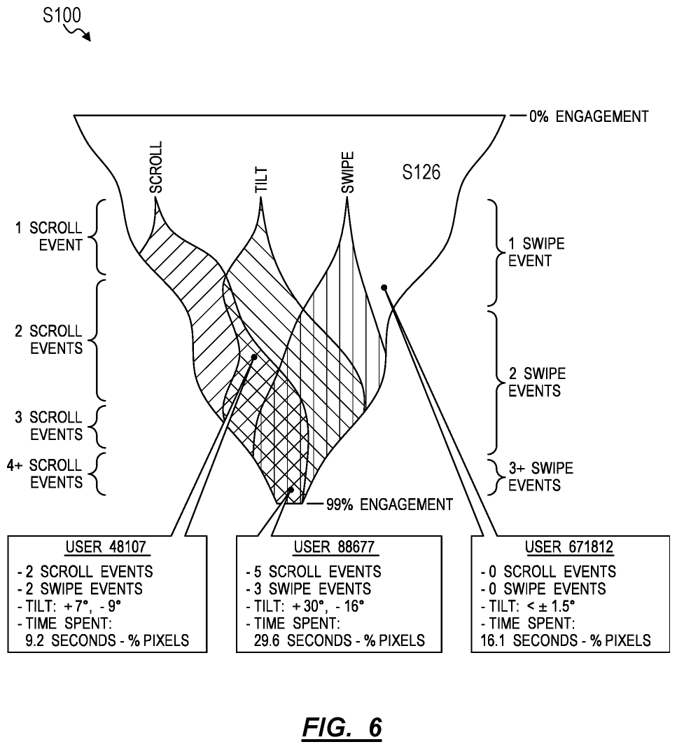

In another implementation shown in FIG. 6, the computer system aggregates advertisement session data—for instances of an advertisement served to a population of users—into a group-less funnel visualization that depicts types and/or degrees of user engagement with this advertisement. For example, for one instance of the advertisement served to a user's computing device, the computer system can aggregate: a time spent value; a number of scroll events; a number of tilt events; a number of swipe events; a duration of video viewed; a number of card views; and/or other metrics for the advertisement session. The computer system can then calculate a score for each of these engagement types, such as proportional to maximum useful engagement levels assigned to each engagement type for the advertisement. For example, the advertisement can specify maximum useful engagement levels of: five scroll events; three swipe events; and a time spent of 30.0% pixel-seconds. The computer system can thus calculate a scroll event score of 40%, a swipe score of 0%, and a time spent score of 65% if two scroll events, no swipe events, and a time spent of 19.5% pixel-seconds occurred during the advertisement session. The computer system can then combine scores for each of these engagement types into a composite engagement score, such as based on weights assigned to each of these engagement types by the advertisement. The computer system can: repeat this process to calculate composite scores for advertisement sessions of other instances of the advertisement served to users during the advertising campaign; and compile these composite scores into a groupless funnel visualization in which advertisement sessions associated with higher composite scores are represented further down the funnel.

However, the computer system can depict user engagement with an advertisement in any other way or format and can present this visualization to a campaign manager or other affiliated entity in any other way. The computer system can also execute the foregoing methods and techniques to update the visualization in (near) real-time as the advertisement is served to users' computing devices.

### 1.9.2 Retargeting Users

In one variation, the computer system can selectively retarget the same advertisement or another advertisement in the same campaign to users in order to move users down the funnel visualization. In particular, the computer system can implement methods and techniques described above to identify a “highly-engaged” user and to flag this user for retargeting—such as by serving a second advertisement in the same advertising campaign to the user soon after engaging the first advertisement—in order to push the user toward a target outcome assigned to the advertisement or advertising campaign.

Similarly, the computer system can implement methods and techniques described above to identify a “moderately-engaged” user and to flag this user for retargeting—such as by serving a second instance of the same advertisement to the user—in order to push the user toward high engagement with the advertisement.

The computer system can also automatically annotate the funnel visualization to indicate which segment of users in the funnel are flagged for retargeting of the same or different advertisement in the advertising campaign, such as to inform the campaign manager of the trajectory of the advertisement.

### 1.9.3 Campaign Adjustment

In one variation, the computer system can also characterize trajectory or success of the advertising campaign based on a shape of the funnel visualization (or based on proportions of users in total unique user, exposed user, engaged user, and highly-engaged user groups represented in the funnel visualization). For example, the computer system can interpret a wide funnel top, narrow funnel center, and wide funnel end as a “polarizing ad” that yields high engagement when served to an interested party but otherwise yields minimal engagement; the computer system then automatically prompt a campaign manager to modify the advertisement to reduce polarization and thus engage for more users. Alternatively, the computer system can automatically isolate common user and environment characteristics of advertisement sessions proximal the funnel end and selectively target the advertisement to users exhibiting these characteristics in similar environments. In another example, the computer system can interpret a wide funnel top, wide funnel center, and narrow funnel end as a “promising ad” that yields high initial user engagement but fails to push users to a CTA; the computer system then automatically prompt a campaign manager to modify the CTA in the advertisement in order to push more users from a engaged state to a highly-engaged state.

In another implementation, the computer system can store a set of funnel visualization templates depicting funnel characteristics of advertising campaigns exhibiting different levels of success, such as: a highly-successful campaign (or “ideal advertising campaign”) with a high ratio of total users to highly-engaged users; a moderately-successful campaign with a moderate ratio of total users to highly-engaged users; a minimally-successful campaign with a low ratio of total users to highly-engaged users; a polarizing campaign with a low ratio of total users to engaged users; a promising campaign with a high ratio of total users to engaged users and a low ratio of engaged users to highly-engaged users. In this implementation, the computer system can identify a funnel visualization template nearest to the funnel visualization generated for an advertising campaign, scale the funnel visualization template to the funnel visualization, overlay this funnel visualization template over the funnel visualization, and present this composite funnel visualization to the campaign manager. Alternatively, the computer system can store a single funnel visualization template (e.g., for an ideal advertising campaign), scale the funnel visualization template to the funnel visualization, overlay this funnel visualization template over the funnel visualization, and present this composite funnel visualization to the campaign manager in order to indicate to the campaign manager how the advertising campaign is tracking relative to an ideal advertising campaign.

However, the computer system can implement data contained in a funnel visualization and/or augment a funnel visualization in any other way to assist a campaign manager.

### 2. Method

As shown in FIG. 7, a method S200 for augmenting mobile advertisements with responsive animations includes, at a remote computer system: serving a first visual element containing a first engagement layer and a first mobile advertisement in an advertising campaign to a mobile device associated with a user, the engagement layer comprising a call to action and defining a responsive animation; accessing a first set of engagement data, representing a first set of interactions between the user and the first engagement layer at the computing device; receiving identification of a second mobile advertisement in the advertising campaign selected for an advertisement slot in a webpage accessed at the mobile device; accessing an engagement layer model linking user interactions with the first engagement layer, advertising content, and user characteristics to a target outcome defined by the advertising campaign; estimating a predicted set of interactions between the user and a second engagement layer for combination with the second advertisement in the advertisement slot in the webpage accessed at the mobile device; and, in response to the predicted set of interactions anticipating the target outcome for the advertising campaign, serving the second engagement layer, to the user.

One variation of the method includes: receiving identification of a mobile advertisement selected for an advertisement slot in a document accessed at a mobile device in Block S210; accessing characteristics of the mobile device in Block S212; selecting an engagement layer, from a set of available engagement layers, based on characteristics of the mobile advertisement and characteristics of the mobile device in Block S220, the engagement layer comprising a call to action and defining a responsive animation; assigning a link associated with the mobile advertisement to the call to action in the engagement layer in Block S222; and serving the engagement layer to the mobile device in Block S224. The method also includes, at an advertisement loaded into the advertisement slot in the document at the mobile device: rendering the mobile advertisement inside the advertisement slot in Block S230; rendering the engagement layer adjacent the mobile advertisement inside the advertisement slot in Block S232; and, in response to a scroll input that moves the advertisement slot within a viewing window rendered on the mobile device, animating the call to action within the engagement layer according to the responsive animation in Block S240.

One variation of the method includes, at the advertisement loaded into the advertisement slot in the document at the mobile device: rendering the mobile advertisement inside the advertisement slot in Block S230; rendering the engagement layer adjacent the mobile advertisement inside the advertisement slot at a first time in Block S232; and animating the call to action within the engagement layer according to the responsive animation based on changes in orientation of the mobile device from an initial orientation of the mobile device at the first time in Block S240.

Another variation of the method includes, at the advertisement loaded into the advertisement slot in the document at the mobile device: rendering the mobile advertisement inside the advertisement slot in Block S230; rendering the engagement layer adjacent the mobile advertisement inside the advertisement slot at a first time in Block S232; and, in response to motion of the mobile device, animating the call to action within the engagement layer according to the responsive animation in Block S240.

Yet another variation of the method includes, at the advertisement loaded into the advertisement slot in the document at the mobile device: rendering the mobile advertisement inside the advertisement slot in Block S230; rendering the engagement layer adjacent the mobile advertisement inside the advertisement slot in Block S232; and, in response to a scroll input that moves the advertisement slot within a viewing window rendered on the mobile device, animating the call to action within the engagement layer and animating the mobile advertisement according to the responsive animation in Block S140.

### 2.1 Applications

Generally, Blocks of the method can be executed by a computer system—such as a remote server functioning as or interfacing with an advertising server—to select an engagement layer that contains a call to action and defines an animation that is responsive to input, such as a scroll, swipe, tilt, or motion event at a mobile device that loaded the engagement layer and a mobile advertisement pair. The computer system can then serve this engagement layer to the mobile device, where an advertisement loaded into an advertisement slot in a document (e.g., a webpage) accessed on this mobile device combines this engagement layer with a mobile advertisement received from the same computer system or from a separate advertising server, including animating the call to action and other content inside the engagement layer (and also animating the mobile advertisement adjacent or wrapped inside of the engagement layer) according to the responsive animation defined by the engagement layer as a user scrolls or swipes over the document or tilts or otherwise moves the mobile device. By thus animating the call the action (and animating the mobile advertisement within or adjacent the engagement layer) as a function of the user's interactions with the mobile device and the document itself, the advertisement can thus draw greater attention from the user, increase the user's comprehension of the mobile advertisement contained inside the advertisement, and increase likelihood that the user will exhibit a target outcome, such as: a “click” on the mobile advertisement or call to action; consumption of a minimum duration of a video contained in the mobile advertisement; a minimum amount of time spent viewing a minimum proportion of the mobile advertisement; a minimum overall engagement; a target brand lift; or a target advertising campaign lift.

### 2.1.1 Engagement Layer and Mobile Advertisement Pairs for Greater User Engagement

In particular, the remote computer system (or an “engagement layer server”) can select an engagement layer predicted to yield a particular outcome for a mobile advertisement selected for a user—such as selected by a separate advertising server—based on: user characteristics (e.g., the user's demographic, location, and historical engagement with various engagement layers and mobile ad); environment characteristics (e.g., device operating system, wireless carrier, wireless connectivity, webpage publisher, and native content on the webpage); and mobile advertisement characteristics (e.g., advertisement format, types of creative contained inside the mobile advertisement, and a type or brand or product depicted in the mobile ad). The remote computer system can thus select and serve the selected engagement layer to an advertisement loaded into an advertisement slot in a webpage accessed on the user's mobile device as the mobile device loads this webpage. The advertising server can approximately concurrently select and serve the mobile advertisement to the advertisement slot as the user's mobile device loads this webpage.

Upon receipt of the engagement layer and the mobile advertisement, the computer system can combine these components to form a composite advertisement that is responsive to user interactions at the mobile device. For example, the mobile advertisement can include a static advertisement. The computer system can wrap the engagement layer around the static advertisement or overlay the engagement layer over the static advertisement in order to transform the static advertisement into a dynamic, responsive composite advertisement, wherein user interactions at the mobile device trigger the advertisement to animate the engagement layer around or across the static advertisement. Alternatively, the mobile advertisement can include a dynamic, responsive advertisement. The computer system can wrap the engagement layer around the dynamic, responsive advertisement or overlay the engagement layer over the dynamic, responsive advertisement in order to form a composite ad: in which content inside the dynamic, responsive advertisement changes responsive to user interactions at the mobile device; in which content inside the engagement layer changes responsive to user interactions at the mobile device; and/or in which the engagement layer visually modifies the dynamic, responsive advertisement as content inside the dynamic, responsive advertisement is also changing responsive to user interactions at the mobile device.

Therefore, the remote computer system and a separate or coextensive advertising server can select an engagement layer and a separate mobile advertisement for local combination at a visual element to form a composite advertisement in order to bring a new interaction to the mobile advertisement—such as matched to user, environment, and mobile advertisement characteristics—and thus increase user engagement with the mobile advertisement. In particular, the engagement layer can define a “mask effect” containing a responsive mask, overlay, or effect that can be applied—by an advertisement—over a fixed or dynamic mobile advertisement in order to: expand responsiveness of the resulting composite advertisement to user interactions; yield a more engaging composite advertisement for the user; and thus improve the outcome of this composite advertisement (e.g., click-through or engagement along a particular target outcome). The remote computer system can also select different engagement layers (or “mask effects”) for a particular mobile advertisement over time—such as for different users, user locations, types of mobile devices, or webpages served the same mobile advertisement—in order to better match (or “customize”) responsive characteristics of the particular mobile advertisement to characteristics of these users.

### 2.1.2 Engagement Layer and Mobile Advertisement Pairs for Responsive Advertisement Options

By storing a population of engagement layers separately from mobile advertisements and selectively serving engagement layers to visual elements for local combination with mobile advertisements, the remote computer system can thus achieve more permutations of mobile advertisement and engagement layer pairs. The remote computer system (in cooperation with a separate or coextensive advertising server) can then strategically target combinations of mobile advertisements and engagement layers (e.g., based on user, environment, and mobile advertisement characteristics) such that the composite mobile advertisements generated at advertisement slots from mobile advertisement and engagement layer pairs draw greater attention from users viewing these composite mobile advertisements and thus yield more successful outcomes (e.g., greater engagement, brand lift, click-through, or conversion) for their original mobile advertisements.

Furthermore, by separating mobile advertisement generation, mobile advertisement storage, and mobile advertisement selection for a user from a responsive effect and call to action—defined in an engagement layer—for the mobile advertisement, the remote computer system can enable rapid deployment of a new mobile advertisement without necessitating selection or testing of a particular effect or call to action for this new mobile advertisement. Rather, the remote computer system can pair this new mobile advertisement with different engagement layers—in the population of existing engagement layers—over time in order to: isolate a singular engagement layer that yields best outcomes (e.g., highest engagement, greatest brand lift) for this new mobile advertisement across a population of users; or isolate particular engagement layers that yield best outcomes for this new mobile advertisement and certain combinations of user and environment characteristics.

Similarly, the remote computer system can enable rapid deployment of a new engagement layer without necessitating selection or testing of the new engagement layer with existing mobile advertisements. Rather, the remote computer system (and/or an advertising server) can pair existing advertisements with a new engagement layer over time to isolate combinations of mobile advertisement, user, and/or environment characteristics that exhibit best outcomes when paired with this new engagement layer.

Blocks of the method are described below as executed by a computer system—such as including a remote advertising server and/or a remote engagement layer server—operating in conjunction with advertisements that: combine mobile advertisement and engagement layers received from the remote computer system to form composite responsive advertisements; present these composite responsive advertisements to users; and record user interactions with these composite responsive advertisements. However, Blocks of the method can be executed by any other local or remote entities to selectively serve a mobile advertisement and a separate engagement layer to a user's mobile device for local combination and presentation to the user, such as based on a target outcome or set of interactions specified for this mobile advertisement, historical user engagement data, and characteristics of the engagement layer. The method is also described below as executed to intelligently serve mobile advertisement and engagement layers to smartphones for local combination of these mobile advertisement and engagement layers into composite advertisements for insertion into webpages viewed within mobile web browsers executing on these smartphones. However, the method can be executed to selectively serve mobile advertisement and engagement layers to other mobile devices (e.g., tablets, smartwatches) for local combination into composite advertisements for insertion into native applications, web browsers, or electronic documents executing on or accessed through these mobile devices. The method can also be executed by a remote computer system to remotely combine mobile advertisement and engagement layers into composite advertisements that are then served to mobile devices for insertion into native applications, web browsers, or electronic documents accessed on these mobile devices.

### 2.2 Visual Element

Generally, the computer system can serve a visual element—containing a mobile advertisement and an engagement layer, configured to record engagement data, and configured to return these engagement data to the computer system—to a user's mobile device. The user's mobile device can then insert this visual element into an advertisement slot within a webpage rendered within a web browser executing on the mobile device. The advertisement can render the mobile advertisement wrapped with or modified by the engagement layer to form an interactive composite advertisement that responds to (i.e., changes responsive to) actions occurring on the mobile device, such as scroll, swipe, tilt, or motion events as described below and shown in FIG. 7.

### 2.2.1 Mobile Advertisement

Generally, a mobile advertisement can include creative content—such as text, iconography, images, and/or video—arranged in a static or responsive advertisement format. In one example, the mobile advertisement includes a static image overlaid with text and containing a link to an external webpage. In another example, the mobile advertisement includes a video configured to start playback when an advertisement slot containing the mobile advertisement enters a viewing window rendered on a mobile device, configured to pause playback when the advertisement slot exits the viewing window on the mobile device, and containing a link to an external webpage. In yet another example, the mobile advertisement includes a set of virtual cards arranged horizontally in a magazine, wherein the magazine is configured to index laterally through the set of cards responsive to swipe inputs over the mobile advertisement, and wherein each card contains a unique image, iconography, and/or text and contains a link to a unique external webpage, such as described in U.S. patent application Ser. No. 15/677,259, filed on 15 Aug. 2017, which is incorporated in its entirety by this reference. In another example, the mobile advertisement includes a sequence of video frames, is configured to index forward through this sequence of video frames responsive to scroll-down inputs at a webpage rendering this mobile advertisement element, is configured to index backward through this sequence of video frames rendered responsive to scroll-up inputs at the webpage rendering this mobile advertisement, and containing a link to an external webpage, such as described in U.S. patent application Ser. No. 15/217,879, filed on 22 Jul. 2016, which is incorporated in its entirety by this reference.

However, the mobile advertisement can include any other type or combination of creative content in any other format and containing a link to any other one or more external resources. A population of mobile advertisements within a body of current advertising campaigns can be stored in a remote database; and an advertising server can select from this population of mobile advertisements to serve to a mobile device for insertion into an advertisement slot within a webpage.

### 2.2.2 Engagement Layer

Generally, an engagement layer can define a wrapper configured to overlay over a mobile device or configured for placement along one or more edges of a mobile advertisement. The engagement layer can also include a call to action (hereinafter “CTA”), such as a textual statement or icon configured to persuade a user to perform a particular task, such as purchasing a product, signing up for a newsletter, or clicking-through to a landing page for a brand or product. For example, the engagement layer can include a generic CTA (e.g., “Click to learn more >>>”) with an empty link, and an advertisement receiving this engagement layer can tie the CTA in the engagement layer to a link—to an external webpage—contained in the mobile advertisement. Alternatively, the engagement layer can include an empty CTA area with an empty link; upon receipt of the engagement layer and a mobile advertisement, an advertisement can identify a call to action in the mobile advertisement, copy this CTA (e.g., text; text and color scheme; or text, color scheme, and iconography) from the mobile advertisement into the empty CTA area within the engagement layer, and tie the CTA area in the engagement layer to a link—to an external webpage—contained in the mobile advertisement. (Alternatively, the remote computer system can transfer or copy CTA content from the mobile advertisement into the engagement layer before serving the engagement layer to the advertisement.) The engagement layer can also include: a background, such as a background color or background image; iconography; generic creative content; and/or empty content areas that the advertisement or remote computer system fills with creative content extracted from a mobile advertisement paired with this engagement layer.

The engagement layer also defines animations or controls for changing the size, color, shape, and/or position of the CTA, background, iconography, generic creative content, and/or empty content areas responsive to inputs at a mobile device rendering a visual element containing the engagement layer, such as swipe, scroll, tilt, or motion (e.g., bounce, shake) events. Thus, when an engagement layer and mobile advertisement pair are loaded into an advertisement slot on a webpage at a mobile device, the visual element can: render the mobile advertisement; render the engagement layer around one or more edges of the mobile advertisement; track user interactions that the mobile advertisement and engagement layer are configured to respond to (which may differ); modify the mobile advertisement responsive to detected user interactions based on a responsive animation defined by the mobile advertisement; and separately modify the engagement layer responsive to detected user interactions based on a responsive animation defined by the engagement layer, as shown in FIG. 4.

In one example, a visual element (e.g., an iframe element) is inserted into an advertisement slot on a webpage accessed at a mobile device; and an advertising server and/or the remote computer system load a mobile advertisement (e.g., creative content arranged statically or dynamically according to an advertisement format) and an engagement layer into the advertisement as the webpage loads on the mobile device. The visual element then: locates the mobile advertisement within the visual element; and locates the engagement layer adjacent one edge (e.g., along a left side, right side, top, or bottom) of the mobile advertisement; (animates the mobile device responsive to an advertisement coming into view of a viewing window rendered on the mobile device based on interactions specified by the mobile advertisement;) and animates the engagement layer based on interactions specified by the engagement layer. Alternatively, the visual element can: locate the engagement layer along multiple edges (e.g., the bottom and right edges) of the mobile advertisement; and locate the mobile advertisement over and inset from the engagement layer such that the engagement layer forms a background or perimeter around the mobile advertisement.

In this example and as shown in FIG. 7, for an engagement layer configured to respond to scroll events, the visual element can animate the engagement layer (or the CTA more specifically) in a direction and at a speed corresponding to a direction and speed of scroll of events occurring at the mobile device as the advertisement is scrolled into, through, and out of a viewing window rendered on the mobile device. In this example, the visual element can: expand a size, zoom into, change a color of (from black and white to color), increase sharpness, bounce at an increasing rate, or pulse at an increasing rate the CTA and/or other visual content within the engagement layer proportional to scroll-down events that bring the engagement layer from the bottom of the viewing window toward the top of the viewing window at the mobile device; and vice versa during scroll-up events that bring the engagement layer down toward the bottom of the viewing window at the mobile device.

Similarly, for an engagement layer configured to respond to motion events (e.g., global motion of the mobile device), the visual element can animate the engagement layer (or the CTA more specifically) in a direction and at a speed corresponding to a direction and speed of motion of the mobile device once the advertisement enters a viewing window rendered on the mobile device. In this example, the visual element can: change a size, shape color of (from black and white to color), or sharpness of the CTA and/or other visual content within the engagement layer and/or bounce, or pulse, or shake the CTA and/or other visual content within the engagement layer proportional to acceleration of the mobile device along one or more axes and/or an angular velocity of the mobile device about one or more axes after a scroll event brings the visual element into the viewing window.

Alternatively, for an engagement layer configured to respond to tilt of the mobile device (e.g., a change in orientation of the mobile device relative to gravity), the visual element can animate the engagement layer (or the CTA more specifically) in a direction and at a speed corresponding to a direction and speed at which the mobile device is tilted once the advertisement enters a viewing window rendered on the mobile device. In this example, the visual element can change or shift the CTA and/or other visual content within the engagement layer laterally or vertically within the advertisement in a direction opposite a change in orientation of the mobile device after a scroll event brings the advertisement into the viewing window.

Additionally or alternatively, an engagement layer can define an effect that is applied across a mobile advertisement loaded into an advertisement. In particular, when loaded into an advertisement slot on a webpage at a mobile device, the visual element can overlay the engagement layer over the mobile advertisement and animate the engagement layer based on user interactions occurring at the mobile device—such as while simultaneously animating the mobile advertisement based on the same or different interaction type. For example, an engagement layer can define a pulse animation in which visual content in the engagement layer and visual content in a mobile advertisement set behind the engagement layer “pulses” proportional to motion of the mobile device, such as at greater frequency and/or amplitude with greater acceleration along one or more axes. In another example, an engagement layer defines a fade animation in which visual content in the engagement layer and visual content in a mobile advertisement set behind the engagement layer “fades” (e.g., from grayscale to color) as the pitch angle of the mobile device deviates from an initial pitch angle recorded when the advertisement is first loaded onto the mobile device. In yet another example, an engagement layer defines a “swoosh” animation in which visual content in the engagement layer and visual content in a mobile advertisement set behind the engagement layer “flies-in” from an edge of the advertisement to a position centered within the advertisement responsive to a scroll-down event that brings the advertisement from the bottom of a viewing window rendered on the mobile device toward the top of the viewing window; and vice versa.

In another example, an engagement layer defines a bounce animation in which visual content in the engagement layer and visual content in a mobile advertisement set behind the engagement layer “bounces” responsive to scroll events at the mobile device. In this example, the engagement layer can store an inertial model that the advertisement implements to inform motion of the engagement layer and mobile advertising content bouncing off of the top edge of the advertisement responsive to a scroll-up event and bouncing off of the bottom edge of the advertisement responsive to a scroll-down event. In yet another example, an engagement layer defines a magnify animation in which areas of the advertisement containing visual content in the engagement layer and visual content in a mobile advertisement set behind the engagement layer is magnified, with this magnification area moving in directions opposite changes in the pitch and roll orientations of the mobile device.

However, an engagement layer can define an animation of any other type responsive to any other user interaction and can contain any other visual content in any other format.

### 2.3 Engagement Data

In one variation, a visual element is also configured to record engagement data and to return these engagement data to a remote computer system—such as at a rate of 5 Hz—once the visual element is loaded into an advertisement slot within a webpage accessed at a mobile device. In this example, the visual element can record: its position in a web browser; a number or proportion of pixels of the visual element in view in the web browser; a running time that a minimum proportion of the visual element has remained in view; a number or instances of clicks on the visual element; vertical scroll events over the webpage; quality of these scroll events; horizontal swipes over the visual element; panes in the visual element viewed or expanded; tilt events and device orientation at the mobile device while the visual element was in view in the web browser; number or instances of hotspots selected; instances or duration of video played within the visual element; video pauses and resumes within the advertisement or an expanded native video player; time of day; type of content on the webpage or other webpage metadata; and/or a unique user identifier. The visual element can compile these engagement data into engagement data packets and return one engagement data packet to the remote computer system, such as once per 200-millisecond interval over the Internet or other computer network.

However, the visual element can define any other file format, can be loaded with a mobile advertisement and/or engagement layer of any other type, and can collect and return engagement data of any other type to the remote computer system in any other way and at any other interval once the visual element is loaded into a webpage rendered within a web browser on a mobile device.

### 2.4 Serving Mobile Advertisements and Engagement Layers

When a user navigates to a publisher's webpage via a web browser executing on her smartphone, tablet, or other mobile device, a web server hosted by the publisher can return content or pointers to content for the webpage (e.g., in Hypertext Markup Language, or “HTML”, or a compiled instance of a code language native to a mobile operating system), including formatting for this content and a publisher advertisement tag that points the web browser or app to the publisher's advertising server (e.g., a network of external cloud servers). The advertising server can then implement an advertisement selector to select a particular mobile advertisement to serve to the web browser—such as based on characteristics of the user, the mobile device, and/or the webpage, etc.—and either: return a visual element containing the selected mobile advertisement directly to the web browser for insertion into a particular advertisement slot in the webpage; or return a second visual element tag that redirects the browser or app to an advertiser or publisher's advertising server. In the latter case, the advertiser or publisher advertising server can return a third visual element tag that redirects the web browser or app to a content delivery network, which may include a network of cloud servers storing raw creative graphics for the advertisement, and the content delivery network can return a visual element containing the selected mobile advertisement to the web browser for insertion into the particular advertisement slot in the webpage.

Concurrently or once the mobile advertisement is thus selected, the remote computer system (e.g., an “engagement layer server”) can implement similar methods and techniques to select an engagement layer—from a population of available engagement layers—for combination with the selected mobile advertisement. For example, the remote computer system can implement an engagement layer model described below to select a particular engagement layer to pair with the selected mobile advertisement based on user and environment characteristics retrieved from the mobile device and based on characteristics of the selected mobile advertisement. In another example, the remote computer system can select a particular engagement layer to pair with the selected mobile advertisement in order to test the particular engagement layer with a particular combination of user, environment, and/or mobile advertisement characteristics present for the particular advertisement slot on this webpage viewed at this user's mobile device. In this example, the remote computer system can thus collect engagement data from the visual element once served to the user's mobile device and loaded into the particular advertisement slot, and the remote computer system (or other computer system) can (re)train the engagement layer model—described below—based on these new engagement data and this particular combination of user, environment, and/or mobile advertisement characteristics.

Upon receipt of the selected mobile advertisement and the particular engagement layer, the visual element can combine the mobile advertisement and the engagement layer to form a composite mobile advertisement and modify the mobile advertisement and the engagement layer—concurrently and independently—based on unique animations defined by each and responsive to user interactions detected at the mobile device, as described above.

### 2.5 Engagement Layer Model

In one variation, the remote computer system implements an engagement layer module to select engagement layers to pair with mobile advertisements served to advertisement slots in webpages viewed on mobile devices based on user, environment, and/or mobile advertisement characteristics of these mobile devices and their affiliated users and based on target outcomes or set of interactions of these mobile advertisement/engagement layer combinations. In particular, the remote computer system (and/or other computer system) can: serve combinations of mobile advertisements and engagement layers to a population of users over time; record mobile advertisement, engagement layer, user, and/or environment data and outcomes of these composite mobile advertisements; derive correlations between user and/or environment characteristics, combinations of mobile advertisements and engagement layers, and outcomes of these composite advertisements; and store these correlations in an engagement layer model (e.g., one generic engagement layer model; one engagement layer model per engagement layer; or one engagement layer per target outcome).

In one implementation, an advertiser or creative may specify a particular target outcome for a new advertising campaign in order to achieve a certain brand lift or a certain cost per customer. Once a mobile advertisement in an advertising campaign is selected for a particular user, the remote computer system can implement the engagement layer model to pair the mobile advertisement with a particular engagement layer predicted to increase a likelihood of achieving a particular target outcome—specified for this advertising campaign—when viewed with the mobile advertisement by the user at the user's mobile device. For example, an advertising campaign can specify a target outcome including: viewability rate (e.g., at least a minimum time spent viewing at least a minimum proportion of an ad); click-through rate (e.g., a minimum proportion of advertisements clicked to total advertisements served); or click-through conversion rate (e.g., a minimum proportion of conversions to total advertisements served). In another example, the advertising campaign can specify a target outcome for an interaction type or rate, such as: a minimum proportion of advertisements for which users scrolled back and forth over the advertisement at least twice (such as described in U.S. patent application Ser. No. 15/816,833) to total advertisements served; a minimum proportion of advertisements for which users selected one hotspot within the advertisement to total advertisements served; a minimum proportion of advertisements for which users swiped laterally through content within the advertisement (such as described in U.S. patent application Ser. No. 15/677,259) to total advertisements served; a minimum proportion of advertisements for which users tilted their mobile devices to view additional content within the advertisement to total advertisements served; a minimum proportion of advertisements for which users viewed video content within the advertisement in a native video player to total advertisements served; etc.

### 2.51 Advertisement Session

As described above, once served to an advertisement slot in a webpage viewed on a user's mobile device, a visual element can return engagement data for the advertisement (e.g., user interactions with the advertisement and mobile device when the visual element is rendered on the mobile device) to the remote computer system, such as at a rate of 5 Hz. The visual element (or the webpage) can also return environment characteristics to the remote computer system, such as: platform (e.g., operating system of the mobile device); device format (e.g., smartphone, smartwatch, or tablet); website or publisher; webpage content; device location; wireless connection type (e.g., WI-FI or cellular); wireless connection speed; and/or network or Internet service provider. The computer system can also access mobile advertisement data, such as: a class or type of brand or product advertised; a format of the mobile advertisement; asset types contained in the mobile advertisement (e.g., text, iconography, images, video, and/or a call to action); and characteristics of a call to action in the mobile advertisement. The computer system can retrieve similar characteristics of the engagement layer selected for this instance of the mobile advertisement served to the user's mobile device. Furthermore, the computer system can retrieve short-term and/or long-term outcomes of this mobile advertisement/engagement layer pair served to the user, such as: click through; overall engagement; conversion; video completion; brand lift; and/or campaign lift.

Upon receipt of a set of engagement data packets from a visual element served to a user's mobile device, the remote computer system can compile these engagement data packets into a session container. For example, the computer system can compile engagement data recorded by the visual element from an initial time that the visual element is loaded into the webpage until the webpage is closed (e.g., by navigating to another webpage or closing the web browser) (i.e., a “session, such as up to a duration of thirty minutes) into a multi-dimensional vector representing all behaviors performed by the user within this session, combinations or orders of these behaviors, and/or advertisement or webpage metadata. The computer system can store this session container with a unique identifier assigned to the user or mobile device at which the user viewed this advertisement.

The computer system can repeat this process to compile engagement data received from other visual elements served to the same mobile device (or to the same user, more specifically) over time into a series of session containers linked to this mobile device (or to this user specifically). The computer system can further implement this process to build a series of session containers linked to other mobile devices (or to other users) within a population based on engagement data received from visual elements—containing mobile advertisement and engagement layer pairs—served to these mobile devices over time.

### 2.52 Model Generation

The remote computer system (or other computer system) can then implement linear regression, artificial intelligence, a convolutional neural network, or other analysis techniques to derive correlations between: engagement layer characteristics, mobile advertisement characteristics, user characteristics, and/or environment characteristics; and outcomes of composite mobile advertisements constructed from mobile/engagement layer pairs. The remote computer system can similarly derive correlations between these characteristics and outcomes of mobile advertisements served to users without engagement layers. For example, the remote computer system can identify: mobile advertisement format and engagement layer animation combinations that correlate with higher frequency instances of scroll events over an advertisement; engagement layers that correlate with higher frequency of conversions when placed in advertisements at the bottom of a webpage; and/or CTA placement and animations in an engagement layer that correlate with higher frequency of brand lift when paired with mobile advertisements advertising a particular category of product (e.g., menswear, vehicles). The remote computer system (or other computer system) can then generate an engagement layer model that represents these correlations, such as: one engagement layer model for each unique engagement layer hosted by the computer system; one engagement layer model representing predicted outcomes for multiple engagement layers applied to mobile advertisements within one advertising campaign; or one engagement layer model representing predicted outcomes for many engagement layers applied to mobile advertisements within any advertising campaign.

However, the remote computer system can implement any other method or technique to train an engagement layer model based on engagement and related data collected through advertisements loaded with mobile advertisement/engagement layer pairs and served to users over time.

2.53 Engagement Layer Selection with Engagement Layer Model

Thus, when serving an engagement layer to a user's mobile device with a selected mobile advertisement, the remote computer system can implement this engagement layer model to select a particular engagement layer predicted to yield a greater likelihood of a particular target outcome specified for the selected mobile advertisement. For example, based on the engagement layer model, the remote computer system can select an engagement layer that defines an animation responsive to scroll events for a user who historically has exhibited a propensity to scroll in both directions over mobile advertisements. In another example in which a particular mobile advertisement is served to a first user at a smartphone and to a second user at a tablet, the remote computer system can: select a first engagement layer defining an animation responsive to motion (e.g., acceleration) to serve to the first mobile device; and select a second engagement layer defining an animation responsive to scroll events to serve to the second mobile device based on the engagement layer model.

However, the remote computer system can select an engagement layer to serve to a user in any other way and according to any other parameter or characteristic.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for an advertising campaign comprising:
serving a first visual element containing a first advertisement in an advertising campaign to a computing device associated with a user;
accessing a first set of engagement data, recorded by the first visual element, representing a first set of interactions between the user and the first advertisement at the computing device;
accessing a model linking user interactions with a set of advertisements within an advertising campaign and a target outcome for the advertising campaign;
estimating a predicted set of interactions between the user and a second advertisement in the advertising campaign, based on the model and the first set of engagement data; and
in response to the predicted set of interactions anticipating the target outcome, serving the second advertisement in the advertising campaign, to the user.

2. The method of claim 1, wherein serving the first visual element containing the first advertisement to the computing device associated with the user further comprises:
at a first time, serving a set of visual elements containing advertising content to a set of computing devices of a population of users;
accessing a corpus of engagement data representing interactions of the population of users with the advertising content presented within the set of visual elements at the set of computing devices;
receiving a target outcome specified by the advertising campaign;
calculating a probability of engagement of each user in the population of users with the first advertisement in the advertising campaign according to the target outcome based on the corpus of engagement data and a predefined intent model for the target outcome;
flagging a subset of users, in the population of users, associated with a greatest probability of engagement with the first advertisement in the advertising campaign according to the target outcome; and
at a second time, in response to receiving a request for an advertisement from a computing device associated with a user in the subset of users, serving the first advertisement, in the advertising campaign, to the user.

3. The method of claim 1, further comprising:
wherein the predicted set of interactions comprises a first predicted set of interactions;
estimating a second predicted set of interactions between the user and a third advertisement in the advertising campaign; and
wherein serving the second advertisement, in the advertising campaign, to the user, comprises
accessing a first target set of interactions associated with the second advertisement that anticipate the target outcome for the advertising campaign;
accessing a second target set of interactions associated with the third advertisement that anticipate the target outcome for the advertising campaign;
calculating a first deviation between the first predicted set of interactions and the first target set of interactions;
calculating a second deviation between the second predicted set of interactions and the second target set of interactions; and
serving the second advertisement, to the user, in response to the first deviation falling below the second deviation and a threshold deviation.

4. The method of claim 1, wherein accessing the first set of engagement data comprises recording the first set of interactions, between the user and the first advertisement at the computing device, comprising:
a first quantity of vertical scrolls over the visual element;
a second quantity of clicks on the visual element;
a third quantity of horizontal swipes over the visual element number; and
a fourth quantity of tilt events at the computing device while the visual element is in view of a viewing window at the computing device.

5. The method of claim 1, wherein serving the first visual element to the computing device associated with the user further comprises:
at a first time, serving a set of visual elements in the advertising campaign to a set of computing devices associated with a first population of users;
accessing a first set of engagement data, representing a series of interactions between the first population of users and the set of visual elements in the advertising campaign;
training an intent model linking interactions with the set of visual elements by the users in the first population of users to the target outcome specified for the advertising campaign;
at a second time, receiving a query for an advertisement from the computing device associated with a user in a second population of users; and
in response to the intent model anticipating the target outcome based on engagement data associated with the user in the second population of users, serving the first visual element in the advertising campaign to the user in the second population of users.

6. The method of claim 1, wherein serving the first visual element to the user comprises:
accessing a target size of the advertising campaign;
selecting a target number of clients in the population of clients to receive the first advertisement in the advertising campaign based on the target size of the advertising campaign;
accessing a target set of interactions for the advertisement linked to the target outcome for the advertising campaign;
for each client in the population of clients
estimating a predicted set of interactions with the first advertisement by the client based on historical engagement data of the client; and
calculating a deviation between the predicted set of interactions and the target set of interactions for the client;
flagging a subset of clients, in the population of clients, to receive the first advertisement, the subset of clients containing the target number of clients and containing clients associated with smallest deviations between predicted set of interactions and the target set of interactions; and
in response to a query for an advertisement from the computing device associated with the user in the subset of clients, serving the first advertisement in the advertising campaign to the computing device.

7. The method of claim 1, further comprising:
receiving a query for an advertisement from a second computing device associated with a second user;
accessing a second set of engagement data, representing a second set of interactions between the second user and a second set of advertisements at the second computing device;
calculating a set of engagement predictions, representing predicted interactions between the second user and the first set of advertisements in the advertising campaign, based on a correlation between the first set of interactions performed by the first user and the second set of interactions performed by the second user;
calculating a predicted sequence of interactions between the second user and the first advertisement in the advertising campaign based on the model and the set of engagement predictions; and
in response to the predicted sequence of interactions anticipating the target outcome, serving the first advertisement in the advertising campaign to the second user.

8. The method of claim 7:
wherein serving the first advertisement in the advertising campaign to the computing device comprises serving the first advertisement in the advertising campaign to the computing device for insertion into a first advertisement slot at a top of a webpage accessed during a first browsing session at the computing device; and
wherein serving the second advertisement in the advertising campaign to the user comprises inserting the second advertisement into a second advertisement slot during the first browsing session and prior to an event that locates the second advertisement slot within a viewing window at the computing device.

9. The method of claim 8, wherein inserting the second advertisement into the second advertisement slot comprises inserting the second advertisement into the second advertisement slot, below the first advertisement slot within the first webpage, prior to a scroll event that locates the second advertisement slot in the viewing window at the computing device during the first browsing session.

10. The method of claim 9:
wherein accessing the first set of engagement data comprises accessing the first set of interactions comprising a first scroll event during the first browsing session following insertion of the first visual element into the first advertisement slot at the top of the webpage;
wherein estimating the predicted set of interactions between the user and the second advertisement in the advertising campaign comprises predicting a second scroll event during the first browsing session based on the first scroll event; and
wherein serving the user the second advertisement comprises serving the second advertisement in response to predicting the second scroll event the locates the second advertisement slot in the viewing window during the first browsing session, the target outcome specifying viewability of the second advertisement.

11. The method of claim 10!, wherein serving the user the second advertisement to the computing device in response to the second scroll event comprises serving the user the second advertisement in response to the second scroll event anticipating a target viewability comprising:
a position of the second advertisement in a viewing window;
a minimum proportion of pixels of the second advertisement rendered in the viewing window; and
a minimum duration of time that pixels of the second advertisement were rendered in the viewing window.

12. The method of claim 7, wherein serving the user the second advertisement comprises inserting the second advertisement into the second advertisement slot on a second webpage, prior to a click event during the first browsing session that locates the second advertisement slot in a viewing window at the computing device.

13. The method of claim 1:
wherein serving the first advertisement in the advertising campaign to the computing device comprises serving the first advertisement in the advertising campaign to the computing device for insertion into a first advertisement slot at a first webpage accessed during a first browsing session at the computing device;
wherein accessing the first set of engagement data comprises:
copying the first set of interactions, recorded by the first advertisement, into the first set of engagement data;
storing the first set of engagement data, associated with the first browsing session, prior to termination of the first browsing session, in a session container associated with the user; and
accessing the first set of engagement data at a start of a second browsing session; and
wherein serving the second advertisement, in the advertising campaign, to the user, comprises inserting the second advertisement into a second advertisement slot, during a second browsing session, prior to a click event that locates the second advertisement slot in a viewing window on a second webpage at the computing device.

14. The method of claim 1, wherein serving the first visual element comprises:
serving an iframe element to the computing device for insertion into an advertisement slot within a webpage accessed at the computing device, the iframe element configured to:
record a second set of engagement data; and
return the second set of engagement data at a rate of 5 Hz once the visual element is loaded into the webpage rendered in a web browser executing on the computing device;
serving a video advertisement advertisement to the computing device for insertion into the iframe element, the iframe element configured to:
initiate playback of the video advertisement in response a scroll event at the computing device that moves the advertisement slot into view within a viewing window rendered on the computing device; and
pause playback of the video advertisement in response to the advertisement slot exiting the viewing window on the computing device; and
serving a link to an external webpage to the computing device, the iframe element configured to trigger the web browser to navigate to the link in response to an input over the iframe element.

15. The method of claim 1, wherein accessing the first set of engagement data comprises:
at a first time, accessing the first set of engagement data representing the first set of interactions between the user and the first advertisement recorded by the first visual element during a first browsing session extending from an initial time that the first visual element was loaded into a webpage at the computing device to a second time that the webpage was closed at the computing device;
storing the engagement data in a multi-dimensional vector, representing interactions performed by the user during the first browsing session, with an identifier of the computing device; and
storing the session container, in a set of session containers associated within the identifier, wherein each session container within the set of session containers represents a set of interactions between the user at the computing device and advertising content loaded onto the computing device over time.

16. The method of claim 1, further comprising:
serving the first advertisement, in the advertising campaign, to a population of users;
segmenting engagement data for the population of users, recorded by the first advertisement, into:
a first group of unique users comprising the population of users;
a second group of exposed users comprising users exposed to greater than a minimum proportion of the advertisement for a minimum duration of time;
a third group of engaged users comprising users exhibiting greater than a minimum interaction with the advertisement; and
a fourth group of highly engaged users exhibiting interactions within a set of target interactions with the advertisement;
retrieving a copy of a parametric funnel visualization defining a trajectory of the advertising campaign;
injecting the four inset groups of users into the parametric funnel visualization to generate a funnel visualization representing a status of user engagement with the advertisement in the advertising campaign across the population of users; and
serving the funnel visualization to a campaign manager associated with the advertising campaign.

17. A method for augmenting mobile advertisements with responsive animations comprising, at a remote computer system:
serving a first visual element containing a first engagement layer and a first mobile advertisement in an advertising campaign to a mobile device associated with a user, the engagement layer comprising a call to action and defining a responsive animation;
accessing a first set of engagement data, representing a first set of interactions between the user and the first engagement layer at the computing device;
receiving identification of a second mobile advertisement in the advertising campaign selected for an advertisement slot in a webpage accessed at the mobile device;
accessing an engagement layer model linking user interactions with the first engagement layer, advertising content, and user characteristics to a target outcome defined by the advertising campaign;
estimating a predicted set of interactions between the user and a second engagement layer for combination with the second advertisement in the advertisement slot in the webpage accessed at the mobile device; and
in response to the predicted set of interactions anticipating the target outcome for the advertising campaign, serving the second engagement layer, to the user.

18. The method of claim 17, further comprising:
during a first period of time:
serving a set of visual elements to a set of computing devices of a population of users, the set of visual elements containing engagement layer and mobile advertisement combinations;
accessing a corpus of engagement data representing interactions of the population of users with the engagement layer and mobile advertisement combinations presented within the set visual elements at the mobile device;
deriving an engagement layer model comprising correlations between user characteristics, combinations of mobile advertisements and engagement layers, and a set of outcomes associated with serving each visual element based on the corpus of engagement data;
during a second period of time:
receiving a target outcome specified by the advertising campaign;
receiving identification of the first mobile advertisement in the advertising campaign selected for insertion in the first visual element;
calculating a probability of engagement of each user in the population of users with the first engagement layer and first mobile advertisement combination according to the target outcome based on the corpus of engagement data and the engagement layer model;
flagging a subset of users, in the population of users, associated with a greatest probability of engagement with the first engagement layer according to the target outcome; and
in response to receiving a request for an advertisement from a computing device associated with a user in the subset of users, serving the first engagement layer, for combination with the first mobile advertisement at the first visual element, to the user.

19. The method of claim 17:
wherein rendering the engagement layer adjacent the mobile advertisement comprises locating the engagement layer adjacent a first edge of the mobile advertisement at the first visual element;
wherein serving the first visual element containing the first engagement layer comprises serving the first visual element containing a first call to action, the first call to action comprising a textual statement; and
wherein serving the first visual element containing the first engagement layer comprises serving the first visual element containing the first engagement layer comprising the first call to action and defining a responsive animation, the responsive animation comprising animating the call to action in a direction and at a speed corresponding to a direction and speed of scroll events occurring at the mobile device as the advertisement is scrolled into, through, and out of a viewing window rendered on the mobile device.

20. The method of claim 17, wherein serving the first engagement layer comprises:
at an initial time, at a computer system affiliated with an advertising platform:
accessing a digital video comprising digital advertising content;
selecting a subset of frames from the digital video; and
compiling the subset of frames into a static image file;
at an advertisement inserted into a webpage rendered within a viewing window of a computing device distinct from the computer system:
in response to a scroll event that moves the advertisement into view in the viewing window, inserting a first region of the static image file into the advertisement, the first region corresponding to a first frame in the subset of frames; and
in response to continuation of the scroll event that moves the advertisement upward within the viewing window, sequentially inserting regions of the static image file, according to an order of frames in the subset of frames, into the advertisement at a rate proportional to the scroll event.

21. A method for an advertising campaign comprising:
serving a first visual element containing a first advertisement in a first advertising campaign to a computing device associated with a user;
accessing a first set of engagement data, recorded by the first visual element, representing a first set of interactions between the user and the first advertisement at the computing device;
accessing a model linking user interactions with a set of advertisements within the first advertising campaign and a target outcome for a second advertising campaign;
estimating a predicted probability of a target outcome for a user with respect to the second advertising campaign, based on the model and the first set of engagement data; and
in response to the predicted probability of the target outcome, serving the second advertisement in the second advertising campaign, to the user.
